(19) United States
(12) Patent Application Publication
(10) Pub. No.: US 2019/0006661 A1
(43) Pub. Date: Jan. 3, 2019

(54) NEGATIVE ELECTRODE ACTIVE MATERIAL, MATERIAL OF MIXED NEGATIVE ELECTRODE ACTIVE MATERIAL, NEGATIVE ELECTRODE FOR NON-AQUEOUS ELECTROLYTE SECONDARY BATTERY, LITHIUM ION SECONDARY BATTERY, METHOD FOR PRODUCING NEGATIVE ELECTRODE ACTIVE MATERIAL, AND METHOD FOR PRODUCING LITHIUM ION SECONDARY BATTERY

(71) Applicant: SHIN-ETSU CHEMICAL CO., LTD., Tokyo (JP)

(72) Inventors: Takumi MATSUNO, Annaka-shi (JP); Takakazu HIROSE, Annaka-shi (JP); Hiromichi KAMO, Takasaki-shi (JP); Masahiro FURUYA, Takasaki-shi (JP); Hidekazu AWANO, Takasaki-shi (JP)

(73) Assignee: SHIN-ETSU CHEMICAL CO., LTD., Tokyo (JP)

(21) Appl. No.: 16/062,889

(22) PCT Filed: Dec. 16, 2016
(86) PCT No.: PCT/JP2016/005148

§ 371 Date: Jun. 15, 2018

(30) Foreign Application Priority Data
Jan. 7, 2016 (JP) 2016-002078

(51) Int. Cl. H01M 4/36; H01M 4/48; H01M 4/587; H01M 10/0525

(52) U.S. Cl. CPC H01M 4/364; H01M 4/483; H01M 2004/027; H01M 4/366; H01M 10/0525; H01M 4/587

(57) ABSTRACT

Negative electrode active material, wherein the negative electrode active material comprises a negative electrode active material particle; the negative electrode active material particle comprises silicon compound particle comprising a silicon compound (SiOₓ: 0.5≤x≤1.6); the silicon compound particle comprises at least any one or more of Li₂SiO₃ and Li₄SiO₄; the negative electrode active material comprises 2% by mass or less of silicon dioxide particle and comprises a silicon dioxide-carbon composite secondary particle comprising a plurality of the silicon dioxide particles and carbon; and the composite secondary particle includes a lithium compound in at least part of a portion other than a silicon dioxide or a silicon compound (SiOₓ: 0.5≤x≤1.6) in the composite secondary particle. The present invention provides a negative electrode active material which can improve a cycle characteristic and a initial charge and discharge characteristics upon using this as the negative electrode active material for a lithium ion secondary battery.

### TECHNICAL FIELD

Present invention relates to a negative electrode active material capable of adsorbing and releasing a lithium ion, a material of mixed negative electrode active material including the negative electrode active material, a negative electrode for a non-aqueous electrolyte secondary battery having a negative electrode active material layer formed of the negative electrode active material, a lithium ion secondary battery using the negative electrode, a method for producing a negative electrode active material, and a method for producing a lithium ion secondary battery.

### BACKGROUND ART

In recent years, small electronic equipment represented by a mobile terminal is widely used, whereby further downsizing, weight saving, and prolonged life are strongly requested. To meet the market needs as mentioned above, a secondary battery which can especially achieve downsizing, weight saving, and high energy density is being developed. This secondary battery is being investigated for application not only to small electronic equipment but also to large electronic equipment represented by an automobile as well as an electric power storage system represented by a house.

Among them, a lithium ion secondary battery has high expectation because not only downsizing and increase in the storage capacity can be easily achieved but also a high energy density can be obtained as compared with a lead battery or a nickel cadmium battery.

The lithium ion secondary battery as mentioned above comprises a positive electrode, a negative electrode, a separator, and an electrolyte solution, wherein the negative electrode thereof includes a negative electrode active material which involves in the charge and discharge reactions.

In the negative electrode active material, a carbon material is widely used, wherein a further increase in the battery capacity is requested from recent market needs. In order to increase the battery capacity, as the material for the negative electrode active material, use of silicon is being studied. This is because a significant increase in the battery capacity can be expected with silicon, for the theoretical capacity of silicon (4199 mAh/g) is more than 10 times as much as the theoretical capacity of graphite (372 mAh/g). Research and development of a silicon material as the material for the negative electrode active material are carried out with regard not only to element silicon but also to compounds represented by an alloy and an oxide thereof. Besides, with regard to the form of the active material, the study is being made from a coating type which is standard in the carbon material to an integral type directly deposited onto a current collector.

However, when silicon is used as a main raw material in the negative electrode active material, the negative electrode active material undergoes expansion and contraction during charge and discharge, so that a crack can readily occur mainly near to surface of the negative electrode active material. In addition, inside the active material an ionic substance, which can cause a crack in the negative electrode active material, is formed. When surface of the negative electrode active material is cracked, a new surface is formed so that the reactive area of the active material increases. At this time, not only a decomposition reaction of the electrolyte solution takes place on the new surface but also the electrolyte solution is consumed because a film of the decomposition product of the electrolyte solution is formed on the new surface. Accordingly, the cycle characteristic can be easily deteriorated.

Until today, in order to improve a battery's initial efficiency and cycle characteristic, various investigations have been made with regard to the electrode configuration as well as the negative electrode material for the lithium ion secondary battery mainly composed of a silicon material.

Specifically, in order to obtain excellent cycle characteristic and high safety, silicon and amorphous silicon dioxide are simultaneously deposited by using a vapor phase method (for example, see Patent Document 1). In order to obtain high battery capacity and high safety, a carbon material (electronic conductive material) is disposed on surface of silicon oxide particle (for example, see Patent Document 2). In order to improve the cycle characteristic as well as to obtain the high input/output characteristics, an active material containing silicon and oxygen is produced, and also an active material layer having a high oxygen ratio near the current collector is formed (for example, see Patent Document 3). In order to improve the cycle characteristic, the silicon active material is made so as to contain oxygen with an average oxygen content of 40 at % or less and also to have a higher oxygen content near the current collector (for example, see Patent Document 4).

In order to improve a first time charge and discharge efficiency, a nano composite including an Si phase, SiO₂, and M_{y}O metal oxide is used (for example, see Patent Document 5). In order to improve the cycle characteristic, a mixture of SiOₓ (0.8≤x≤1.5 and a particle diameter range of 1 to 50 μm) with a carbon material is burned at high temperature (for example, see Patent Document 6). In order to improve the cycle characteristic, a molar ratio of oxygen to silicon in the negative electrode active material is made 0.1 to 1.2, and the active material is controlled such that the difference between the maximum and minimum values of the molar ratio near the interface of the active material and the current collector is in the range of 0.4 or less (for example, see Patent Document 7). In order to improve the battery load characteristics, a metal oxide including lithium is used (for example, see Patent Document 8). In order to improve the cycle characteristic, a hydrophobic layer of a silane compound or the like is formed on the silicon material surface layer (for example, see Patent Document 9). In order to improve the cycle characteristic, silicon oxide is used, and on the surface layer thereof, a graphite coating film is formed so as to provide conductivity (for example, see Patent Document 10). In Patent Document 10, with regard to the shift values obtained from the Raman spectrum of the graphite film, broad peaks are appeared at 1330 cm⁻¹ and 1580 cm⁻¹ with the intensity ratio I₁₃₃₀/I₁₅₈₀ being 1.5<I₁₃₃₀/I₁₅₈₀<3. In order to obtain a high battery capacity and to improve the cycle characteristic, particle having a silicon microcrystal phase dispersed in silicon dioxide are used (for example, see Patent Document 11).

In order to improve the over-charge and over-discharge characteristics, a silicon oxide in which an atom number ratio of silicon to oxygen is controlled at 1:y (0<y<2) is used (for example, see Patent Document 12).

### CITATION LIST

### Patent Literatures

### Patent Document 1: Japanese Unexamined Patent Publication (Kokai) No. 2001-185127

### Patent Document 2: Japanese Unexamined Patent Publication (Kokai) No. 2002-042806

### Patent Document 3: Japanese Unexamined Patent Publication (Kokai) No. 2006-164954

### Patent Document 4: Japanese Unexamined Patent Publication (Kokai) No. 2006-114454

### Patent Document 5: Japanese Unexamined Patent Publication (Kokai) No. 2009-070825

### Patent Document 6: Japanese Unexamined Patent Publication (Kokai) No. 2008-282819

### Patent Document 7: Japanese Unexamined Patent Publication No. 2008-251369

### Patent Document 8: Japanese Unexamined Patent Publication (Kokai) No. 2008-177346

### Patent Document 9: Japanese Unexamined Patent Publication (Kokai) No. 2007-234255

### Patent Document 10: Japanese Unexamined Patent Publication (Kokai) No. 2009-212074

### Patent Document 11: Japanese Unexamined Patent Publication (Kokai) No. 2009-205950

### Patent Document 12: Japanese Patent No. 2997741

### DISCLOSURE OF THE INVENTION

### Problems to be Solved by the Invention

As mentioned above, in recent years, in small mobile equipment represented by electronic equipment, enhancement of performance and multi-functionalization are being progressing, whereby requiring an increase in the battery capacity of a lithium ion secondary battery, which is a main power source thereof. As one method to solve this problem, the lithium ion secondary battery provided with a negative electrode using a silicon material as a main material thereof is desired to be developed. In addition, in the lithium ion secondary battery using the silicon material, a first time efficiency and a cycle characteristic that are almost equivalent to those of the lithium ion secondary battery using a carbon material are requested. However, a negative electrode active material showing the first efficiency and cycle stability that are equivalent to those of the lithium ion secondary battery using the carbon material has not been proposed yet.

The present invention was made in view of the problems mentioned above, and it is an object of the present invention to provide a negative electrode active material that can improve the cycle characteristic as well as the initial charge and discharge characteristics when this is used as the negative electrode active material of the lithium ion secondary battery. Also, it is an object of the present invention to provide: a material of mixed negative electrode active material including the negative electrode active material; a negative electrode for a non-aqueous electrolyte secondary battery having a negative electrode active material layer formed with the material of mixed negative electrode active material; and a lithium ion secondary battery using the negative electrode. Also it is an object of the present invention to provide a method for producing the negative electrode active material as well as a method for producing a lithium ion secondary batter using the negative electrode active material produced by the method.

### Means for Solving the Problems

In order to achieve the objects mentioned above, the present invention provide a negative electrode active material, wherein the negative electrode active material includes a negative electrode active material particle; the negative electrode active material particle includes silicon compound particle including a silicon compound (SiOₓ: 0.5≤x≤1.6); the silicon compound particle includes at least any one or more of Li₂SiO₃ and Li₄SiO₄; the negative electrode active material includes 2% by mass or less of silicon dioxide particle and included a silicon dioxide-carbon composite secondary particle including a plurality of the silicon dioxide particles and carbon; and the composite secondary particle includes a lithium compound in at least part of a portion other than a silicon dioxide or a silicon compound (SiOₓ: 0.5≤x≤1.6) in the composite secondary particle.

Because the negative electrode active material of the present invention includes the negative electrode active material particle including the silicon compound particle, the battery capacity can be improved (the negative electrode active material particle including the silicon compound particle is also referred to as silicon-based active material particle). In addition, because a silicon dioxide component portion in the silicon compound is reformed to a lithium silicate in advance, the portion being destabilized during insertion and release of lithium during battery's charging and discharging, an irreversible capacity generated during charging can be reduced. In addition, when the negative electrode active material includes 2% by mass or less of the silicon dioxide particle, the silicon oxide-carbon composite secondary particle including the lithium compound is formed as mentioned above; and thus, the electronic conductivity and ion diffusivity of the negative electrode active material can be improved. Accordingly, when the negative electrode active material like this is used as the negative electrode active material of the non-aqueous electrolyte secondary battery, excellent cycle characteristic and excellent initial charge and discharge characteristics can be obtained.

At this time, it is preferable that the composite secondary particle further includes the silicon compound particle and that an average particle diameter of the composite secondary particle is 1 μm or more and 15 μm or less.

The composite secondary particle like this can suppress local variance in capacity of the negative electrode active material, so that when the negative electrode active material including the composite secondary particle like this is used as the negative electrode active material for the non-aqueous electrolyte secondary battery, more excellent cycle characteristic can be obtained.

In addition, it is preferable that a rate of carbon in the composite secondary particle is in a range of 60 at % or more.

When the rate of carbon in the composite secondary particle is in the above-mentioned range, the electronic conductivity can be enhanced more effectively, so that when the negative electrode active material including the composite secondary particle as mentioned above is used as the negative electrode active material of the non-aqueous electrolyte secondary battery, further enhancement can be obtained in the cycle characteristic.

In the silicon compound particle included in the composite secondary particle, it is preferable that Xₛ and X are in a relationship of Xₛ<X, wherein Xₛ is defined as an oxygen/silicon molar ratio in a region of 5 nm or less from surface of the silicon compound particle and X is defined as an oxygen/silicon molar ratio in a region of 100 nm or more from surface of the silicon compound particle.

When the silicon compound particle included in the composite secondary particle has the structure as mentioned above, the lithium ion conductivity in the negative electrode active material can be improved; and thus, when the negative electrode active material including the composite secondary particle as mentioned above is used as the negative electrode active material for the non-aqueous electrolyte secondary battery, more excellent cycle characteristic can be obtained.

It is preferable that in the silicon compound particle, a half-value width (2θ) of a diffraction peak attributable to a Si(111) crystal plane obtained from an X-ray-diffraction is 1.20 or more, and a crystallite's size corresponding to this crystal plane is 7.5 nm or less.

When the negative electrode active material in which the silicon compound particle has the silicon crystallinity as mentioned above, is used as the negative electrode active material for the lithium ion secondary battery, more excellent cycle characteristic can be obtained.

In addition, it is preferable that the silicon compound particle satisfies a relationship that A>B, wherein A is a maximum peak strength value in a Si and a Li silicate regions given as a chemical shift value of −60 ppm to −95 ppm and B is a peak strength value in a SiO₂ region given as a chemical shift value of −96 ppm to −150 ppm, these peaks being obtained from a ²⁹Si-MAS-NMR spectrum thereof.

In the silicon compound particle, when amounts of Si and Li₂SiO₃ are larger as compared with the SiO₂ component as the standard, the negative electrode active material can have a sufficient improvement effect in the battery characteristics due to the Li insertion.

It is preferable that a test cell is prepared, the test cell comprising a negative electrode, which includes a mixture of the negative electrode active material and a carbon-based active material, and a counter lithium; in the test cell, charge in which a current is flowed so as to insert lithium into the negative electrode active material and discharge in which a current is flowed so as to release lithium from the negative electrode active material are executed for 30 times; and when a graph is drawn showing a relationship between a differential value dQ/dV, which is obtained by differentiating a discharge capacity Q in each charge and discharge with an electric potential V of the negative electrode with a standard of the counter lithium, and the electric potential V, the differential value dQ/dV upon discharging after X^{th} time (1≤X≤30) has a peak in a range of 0.40 V to 0.55 V of the electric potential V of the negative electrode.

The peak in the V-dQ/dV curve mentioned above resembles the peak of a silicon material. Because the discharge curve in a higher electric potential side rises sharply, a capacity can be readily expressed upon battery design. In addition, when the peak appears within 30 times of the charge and discharge, it can give the negative electrode active material formed with a stable bulk. It is preferable that the negative electrode active material particles has a median diameter of 1.0 μm or more and 15 μm or less.

If the median diameter is 1.0 μm or more, increase in the battery's irreversible capacity due to the increase in the surface area per mass can be suppressed. On the other hand, if the median diameter is made 15 μm or less, the particle is difficult to be cracked so that new surface is difficult to be emerged.

It is preferable that the silicon compound particle has a carbon coating film on a surface thereof.

When the silicon compound particle has a carbon coating film on the surface thereof, improvement in the conductivity can be obtained.

It is preferable that an average thickness of the carbon coating film is 10 nm or more and 5000 nm or less.

When the average thickness of the carbon coating film is 10 nm or more, the conductivity thereof can be improved. On the other hand, when the average thickness of the carbon coating film is 5000 nm or less, by using the negative electrode active material including the silicon compound particle like this in the non-aqueous electrolyte secondary battery, sufficient amount of the silicon compound included in the silicon compound particle can be ensured, so that the decrease in the battery capacity can be suppressed.

In addition, the present invention provides a material of mixed negative electrode active material including the negative electrode active material and a carbon-based active material.

Accordingly, when the material for forming a negative electrode active material layer is made so as to include a carbon-based active material as well as the negative electrode active material of the present invention (silicon-based negative electrode active material), not only conductivity of the negative electrode active material layer can be improved but also an expansion stress due to charging can be relaxed. In addition, by mixing the silicon-based negative electrode active material with the carbon-based active material, the battery capacity can be increased.

In addition, the present invention provides a negative electrode for a non-aqueous electrolyte secondary battery wherein the negative electrode contains the material of mixed negative electrode active material, and a ratio of a mass of the negative electrode active material relative to a total mass of the negative electrode active material and the carbon-based active material is 6% by mass or more.

When the ratio of the mass of the negative electrode active material (silicon-based negative electrode active material) relative to a total mass of the negative electrode active material (silicon-based negative electrode active material) and the carbon-based active material is 6% by mass or more, further improvement in the battery capacity can be obtained.

In addition, the present invention provides a negative electrode for a non-aqueous electrolyte secondary battery comprising: a negative electrode active material layer formed by the material of mixed negative electrode active material; and a negative electrode current collector, wherein the negative electrode active material layer is formed on the negative electrode current collector, and the negative electrode current collector includes carbon and sulfur with the contents of each being 100 ppm by mass or less.

When the negative electrode current collector constituting the negative electrode contains carbon and sulfur with the amounts as shown above, deformation of the negative electrode upon charging can be suppressed.

In addition, the present invention provides a lithium ion secondary buttery wherein a negative electrode including the negative electrode active material is used as the negative electrode thereof.

In the lithium ion secondary buttery using the negative electrode which includes the negative electrode active material like this, a high capacity as well as excellent cycle characteristic and excellent initial charge and discharge characteristics can be obtained.

In addition, the present invention provides a method for producing a negative electrode active material, the method being a method for producing a negative electrode active material including negative electrode active material particles which includes silicon compound particle, and the method comprising: preparing the negative electrode active material, the preparing the negative electrode active material comprising making silicon compound particle which includes a silicon compound (SiOₓ: 0.5≤x≤1.6), compounding carbon with the silicon compound particle, and inserting Li into the silicon compound particle so as to include at least any one or more of Li₂SiO₃ and Li₄SiO₄ in the silicon compound particle; and selecting a negative electrode active material which includes 2% by mass or less of silicon dioxide particle and includes a silicon oxide-carbon composite secondary particle including a plurality of the silicon oxide particles and carbon, the composite secondary particle including a lithium compound in at least part of a portion other than a silicon dioxide or a silicon compound (SiOₓ: 0.5≤x≤1.6) in the composite secondary particle from a negative electrode active material including the prepared negative electrode active material particle.

When the negative electrode active material is produced by selecting the silicon-based active material particle in the way as mentioned above, the negative electrode active material having not only a high capacity but also excellent cycle characteristic and excellent initial charge and discharge characteristics upon using it as the negative electrode active material for the non-aqueous electrolyte secondary battery can be produced.

In addition, the present invention provides a method for producing a lithium ion secondary battery, wherein a negative electrode is produced by using the negative electrode active material produced by the method for producing the negative electrode active material, and the lithium ion secondary battery is produced by using the negative electrode thus produced.

By using the negative electrode active material produced in the way as mentioned above, the lithium ion secondary battery having not only a high capacity but also excellent cycle characteristic and excellent initial charge and discharge characteristics can be produced.

### Advantageous Effect of Invention

As mentioned above, when the negative electrode active material of the present invention is used as the negative electrode active material for the secondary battery, not only a high capacity but also excellent cycle characteristic and excellent initial charge and discharge characteristics can be obtained. In addition, the same effects can be obtained in the material of mixed negative electrode active material, the negative electrode, and the lithium ion secondary battery which include the negative electrode active material mentioned above. Further, according to the method for producing the negative electrode active material of the present invention, the negative electrode active material having not only a high capacity but also excellent cycle characteristic and excellent initial charge and discharge characteristics can be produced when this is used as the negative electrode active material for the lithium ion secondary battery.

### BRIEF DESCRIPTION OF DRAWINGS

FIG. 1 is a cross-sectional view showing a composition of the negative electrode for the non-aqueous electrolyte secondary battery of the present invention.

FIG. 2 is an inner-bulk reforming apparatus which is used to electrochemically insert and release lithium at the time when the negative electrode active material of the present invention is produced.

FIG. 3 is a figure illustrating a composition example (laminate film type) of the lithium secondary battery of the present invention.

FIG. 4 is a graph showing the relationship between the ratio of the silicon-based active material particle relative to the total amount of the negative electrode active material and the rate of increase in the battery capacity of the secondary battery.

### BEST MODES FOR CARRYING OUT THE INVENTION

Hereinafter, embodiments of the present invention will be explained as examples thereof with referring to the drawings; however, the present invention is not limited thereto.

As mentioned above, as one method to increase a battery capacity of the lithium ion secondary battery, it is investigated to use a negative electrode, which uses a silicon material as a main material, as a negative electrode for the lithium ion secondary battery. It is desired that the lithium ion secondary battery using this silicon material has the initial charge and discharge characteristics and the cycle characteristic that are almost equivalent to those of the lithium ion secondary battery using the carbon material. However, a negative electrode active material showing the initial charge and discharge characteristics and the cycle stability that are equivalent to those of the lithium ion secondary battery using the carbon material was not proposed yet.

Therefore, the present inventors have conducted studies of the negative electrode active material giving excellent characteristics when it is used as a negative electrode for the lithium ion secondary battery. As a result, it was found that if the negative electrode active material particles that is included in the negative electrode active material includes silicon compound particle including a silicon compound (SiOₓ: 0.5≤x≤1.6), and the silicon compound particle includes at least any one or more of Li₂SiO₃ and Li₄SiO₄, and the negative electrode active material includes 2% by mass or less of silicon dioxide particle and includes silicon oxide-carbon composite secondary particle including a plurality of the silicon oxide particles and carbon; and the composite secondary particle includes a lithium compound in at least part of a portion other than a silicon dioxide or a silicon compound (SiOₓ: 0.5≤x≤1.6) in the composite secondary particle, excellent cycle characteristic and excellent initial charge and discharge characteristics can be obtained upon using this negative electrode active material as the negative electrode active material for the lithium ion secondary battery, thereby bringing the present invention to the completion.

### <Negative Electrode for the Non-Aqueous Electrolyte Secondary Battery>

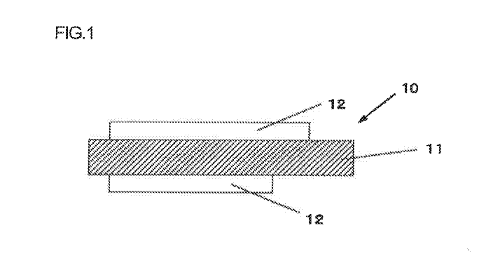

First, the negative electrode for the non-aqueous electrolyte secondary battery will be explained. FIG. 1 illustrates a cross-sectional composition of the negative electrode for the non-aqueous electrolyte secondary battery (hereinafter, described as “negative electrode”) in one embodiment of the present invention.

### [Composition of the Negative Electrode]

As illustrated in FIG. 1, a negative electrode 10 has a composition in which a negative electrode active material layer 12 is arranged on a negative electrode current collector 11. Alternatively, the negative electrode active material layer 12 may be formed on both surfaces of the negative electrode current collector, or only on one surface thereof. Further, the negative electrode current collector may not be used when the negative electrode active material of the present invention is used.

### [Negative Electrode Current Collector]

The negative electrode current collector 11 is an excellent conductive material and formed of a mechanically strong material. Illustrative example of the conductive material includes copper (Cu) and nickel (Ni). It is preferable that the conductive material does not form an intermetallic compound with lithium (Li).

It is preferable that the negative electrode current collector 11 includes carbon (C) and sulfur (S), in addition to main elements. This is because a physical strength of the negative electrode current collector can be increased by so doing. Especially in the case that the negative electrode has an active material layer which expands upon charging, if the current collector includes the elements mentioned above, deformation of the electrode including the current collector can be suppressed. Contents of these elements are not particularly restricted; but especially, it is preferable that content of each element is 100 ppm by mass or less. This is because a higher effect to suppress the deformation can be obtained.

Surface of the negative electrode current collector 11 may be roughened or not be roughened. Illustrative example of the roughed negative electrode current collector includes a metal foil having been subjected to an electrolysis treatment, an emboss treatment, or a chemical etching treatment. Illustrative example of the negative electrode current collector that is not roughened includes a rolled metal foil.

### [Negative Electrode Active Material Layer]

The negative electrode active material layer 12 includes the negative electrode active material of the present invention which can adsorb and release a lithium ion; and in addition, in view of a battery design, it may include other materials such as a negative electrode binder and a conductive assistant. The negative electrode active material includes the negative electrode active material particle, and the negative electrode active material particle includes the silicon compound particle including the silicon compound (SiOₓ: 0.5≤x≤1.6).

In addition, the negative electrode active material layer 12 may include the material of mixed negative electrode active material including the negative electrode active material of the present invention and the carbon-based active material. With these, not only an electric resistance of the negative electrode active material layer can be lowered but also an expansion stress due to charging can be relaxed. Illustrative example of the carbon-based active material usable includes a thermally decomposed carbon, a coke, a glass-like carbon fiber, a burned organic polymer compound body, and a carbon black.

In the negative electrode of the present invention, it is preferable that the ratio of the mass of the negative electrode active material (silicon-based negative electrode active material) of the present invention relative to the total mass of the negative electrode active material (silicon-based negative electrode active material) and the carbon-based active material is 6% by mass or more. If the ratio of the mass of the negative electrode active material of the present invention to the total mass of the negative electrode active material of the present invention and the carbon-based active material is 6% by mass or more, increase in the battery capacity can be ensured.

The negative electrode active material of the present invention is the silicon oxide material which includes the silicon compound particle, and the silicon compound particle includes the silicon compound (SiOₓ: 0.5≤x≤1.6) as mentioned before; however, in the composition thereof, it is more preferable when x approaches near to 1. This is because an excellent cycle characteristic can be obtained by so doing. Meanwhile, composition of the silicon compound in the present invention does not necessarily mean a purity of 100%, so that it may contain minute amounts of impurity elements.

In the negative electrode active material of the present invention, the silicon compound particle includes at least any one or more of Li₂SiO₃ and Li₄SiO₄. These are the materials in which a SiO₂ component portion that is destabilized upon insertion and release of lithium during charging and discharging of the battery are reformed to different lithium silicates in advance; and thus, the irreversible capacity generated upon charging can be reduced.

When at least any one or more of Li₄SiO₄ and Li₂SiO₃ is present in the bulk of the silicon compound particle, the battery characteristics can be improved; however, when these two Li compounds are present concurrently, the battery characteristics can be improved furthermore. Meanwhile, these lithium silicates can be quantified by NMR (Nuclear Magnetic Resonance) or XPS (X-ray Photoelectron Spectroscopy). Measurements of XPS and NMR can be made, for example, by the following conditions.

### XPS

Instrument: X-ray photoelectron spectroscopy instrument
X-ray source: mono-colored Al Kα beam
X-ray spot diameter: 100 μm
Ar ion gun sputtering condition: 0.5 kV/2 mm×2 mm ²⁹Si MAS NMR (magic angle spinning nuclear magnetic resonance)
Instrument: 700 NMR spectrophotometer (manufactured by Bruker Corp.)
Probe: 4 mm HR-MAS rotor 50 μL
Sample rotation speed: 10 kHz
Measured environment temperature: 25° C.

The negative electrode active material of the present invention includes 2% by mass or less of silicon dioxide particle and includes silicon oxide-carbon composite secondary particle including a plurality of the silicon oxide particles and carbon, wherein the composite secondary particle includes a lithium compound in at least part of a portion other than a silicon dioxide or a silicon compound (SiOₓ: 0.5≤x≤1.6) in the composite secondary particle. The silicon dioxide particle is represented by SiO₂ as the composition in the primary particle, so that this is distinguished from the silicon compound particle whose composition in the primary particle is represented by SiOₓ (0.5≤x≤1.6). Because the composite secondary particle includes carbon, the electronic conductivity of the negative electrode active material can be improved; and thus, when the negative electrode active material like this is used as the negative electrode active material for the non-aqueous electrolyte secondary battery, excellent cycle characteristic as well as initial charge and discharge characteristics can be obtained. In addition, the composite secondary particle includes a lithium compound in at least part of the portion other than the silicon dioxide or the silicon compound (SiOₓ: 0.5≤x≤1.6) (it may be present in the carbon component, but may also be present in the interface between the carbon phase and the silicon dioxide or the silicon compound, or in surface of the carbon phase), so that the irreversible component in the carbon component is supplemented; and thus, the first efficiency of the negative electrode active material can be improved. In addition, even after the negative electrode active material produced is washed before the slurry for the negative electrode is produced, part of the component having a Li conductivity such as lithium carbonate remains in the carbon component; and thus, the ion diffusivity thereof can be improved. As a result, the first time efficiency as well as the cycle characteristic can be improved. When the content of the silicon dioxide particle included in the negative electrode active material is in the range of 2% by mass or less, the effects as mentioned above (electronic conductivity, first time efficiency, and ion diffusivity) due to formation of the secondary particle (aggregate) can be obtained; and thus, the battery performance can be improved as compared with the case in which the secondary particle is not formed. Meanwhile, the content of the silicon dioxide particle, presence or absence of the composite secondary particle, and presence or absence of the lithium compound in the negative electrode active material can be measured by carrying out the shape observation and elemental analysis by using SEM-EDX (scanning electron microscope-energy dispersive X-ray spectroscopy) or the like.

In the negative electrode active material of the present invention, it is preferable that the composite secondary particle further includes the silicon compound particle and that the average particle diameter of the composite secondary particle is 1 μm or more and 15 μm or less. The composite secondary particle like this can suppress local variance in capacity of the negative electrode active material, so that when the negative electrode active material including the composite secondary particle like this is used as the negative electrode active material for the non-aqueous electrolyte secondary battery, more excellent cycle characteristic can be obtained. Meanwhile, presence or absence of the silicon compound particle in the composite secondary particle as well as the average particle diameter of the composite secondary particle can be measured by carrying out the shape observation and elemental analysis by using SEM-EDX or the like.

In the negative electrode active material of the present invention, the rate of carbon in the composite secondary particle is preferably 60 at % or more. Here, “at %” means the rate (%) expressed by ratio of atomic number. When the rate of carbon in the composite secondary particle is in the above-mentioned range, the electronic conductivity can be improved more effectively; and thus, when the negative electrode active material including the composite secondary particle as mentioned above is used as the negative electrode active material for the non-aqueous electrolyte secondary battery, more excellent cycle characteristic can be obtained. Meanwhile, the rate of carbon in the composite secondary particle can be measured by carrying out the shape observation and elemental analysis by using SEM-EDX or the like.

In the silicon compound particle included in the composite secondary particle, it is preferable that Xₛ and X are in a relationship of Xₛ<X, wherein Xₛ is defined as the oxygen/silicon molar ratio in a region of 5 nm or less from surface of the silicon compound particle (surface region) and X is defined as the oxygen/silicon molar ratio in a region of 100 nm or more from surface of the silicon compound particle (inside region). When the silicon compound particle included in the composite secondary particle has the structure as mentioned above, the lithium ion conductivity in the negative electrode active material can be improved; and thus, when the negative electrode active material including the composite secondary particle as mentioned above is used as the negative electrode active material for the non-aqueous electrolyte secondary battery, more excellent cycle characteristic can be obtained. Meanwhile, the relationship between Xₛ and X can be measured by identifying the SiOₓ surface by the cross-sectional TEM observation and by composition analysis by XPS.

In the silicon compound particle of the present invention, it is preferable that the half-value width (2θ) of the diffraction peak attributable to the Si(111) crystal plane obtained from the X-ray-diffraction is 1.2° or more, and that the crystallite's size corresponding to this crystal plane is 7.5 nm or less. Silicon crystallinity of the silicon compound in the silicon compound particle is better as the crystallinity thereof is lower; and thus, especially when amount of the Si crystal is small, not only the battery characteristics can be improved but also a stable Li compound can be produced.

In addition, it is preferable that the negative electrode active material of the present invention satisfies in the silicon compound particle therein a relationship A>B, wherein A is a maximum peak strength value in a Si and a Li silicate regions given as a chemical shift value of −60 ppm to −95 ppm and B is a peak strength value in a SiO₂ region given as a chemical shift value of −96 ppm to −150 ppm, these values being obtained from a ²⁹Si-MAS-NMR spectrum. In the silicon compound particle, when amount of the silicon component or of Li₂SiO₃ is comparatively large relative to the SiO₂ component which is taken as the standard, a sufficient improvement effect in the battery characteristics due to the Li insertion can be obtained.

In the negative electrode active material of the present invention, it is preferable that a test cell is prepared which comprises a negative electrode, which includes a mixture of the negative electrode active material and a carbon-based active material, and a counter lithium; in the test cell, charge in which a current is flowed so as to insert lithium into the negative electrode active material and discharge in which a current is flowed so as to release lithium from the negative electrode active material are executed for 30 times; and when a graph is drawn showing a relationship between a differential value dQ/dV, which is obtained by differentiating a discharge capacity Q in each charge and discharge with an electric potential V of the negative electrode with a standard of the counter lithium, and the electric potential V, the differential value dQ/dV upon discharging on and after X^{th} time (1≤X≤30) has a peak in a range of 0.40 V to 0.55 V of the electric potential V of the negative electrode. The peak in the V-dQ/dV curve mentioned above resembles the peak of a silicon material. Because the discharge curve in a higher electric potential side rises sharply, a capacity can be readily expressed upon battery design. In addition, when the peak appears within 30 times of the charge and discharge, it can be judged that a stable bulk is formed.

In addition, in the negative electrode active material of the present invention, it is preferable that the median diameter (D₅₀: particle diameter when the cumulative volume reaches 50%) of the negative electrode active material particles is 1.0 μm or more and 15 μm or less. This is because when the median diameter is within the above-mentioned range, not only adsorption and release of the lithium ion upon charging and discharging is facilitated but also the particle is difficult to be cracked. When the median diameter is 1.0 μm or more, the surface area per a unit mass can be made small, so that increase in the battery's irreversible capacity can be suppressed. On the other hand, when the median diameter is made 15 μm or less, the particle is difficult to be cracked, so that a new surface is difficult to emerge.

In the negative electrode active material of the present invention, it is preferable that the silicon compound particle has a carbon coating film on the surface thereof. When the silicon compound particle has the carbon coating film on the surface thereof, improvement of the conductivity can be obtained. The silicon compound particle that forms the composite secondary particle may have the carbon coating film independently, or may have the carbon coating film co-owned with other silicon dioxide particle and/or silicon compound particle that constitute the composite secondary particle. In this case, pluralities of the silicon oxide particle and/or silicon compound particle are included in the continuous carbon coating film.

In addition, if the average thickness of the carbon coating film is 10 nm or more, improvement in the conductivity can be obtained. On the other hand, if the average thickness of the carbon coating film is 5000 nm or less, when the negative electrode active material including the silicon compound particle having the carbon coating film like this is used for the non-aqueous electrolyte secondary battery, sufficient amount of the silicon compound included in the negative electrode active material can be ensured; and thus, decrease in the battery capacity can be suppressed.

The average thickness of this carbon coating film can be calculated, for example, by the procedure shown below. First, the negative electrode active material particles is observed with TEM (transmission electron microscope) with an arbitrary magnification. With regard to the magnification, it is preferable that with this magnification the thickness of the carbon coating film can be visually confirmed so as to measure the thickness thereof. Next, the thickness of the carbon coating film is measured in arbitrary 15 spots. At this time, it is preferable to set the measurement spots widely and randomly, not to concentrate to a certain spot as much as possible. Finally, the average value of the thicknesses of the 15 spots in the carbon coating film is calculated.

The covering rate of the carbon coating film is not particularly restricted; however, the rate as high as possible is preferable. The covering rate of 30% or more is preferable because the electric conductivity can be improved furthermore. The covering method of the carbon coating film is not particularly restricted; however, a sugar carbonization method and a thermal decomposition method of a hydrocarbon gas are preferable. This is because the covering rate can be improved by these methods.

As to the negative electrode binder included in the negative electrode active material layer, for example, any one or more of a polymer material, a synthetic rubber, etc. can be used. Illustrative example of the polymer material includes polyvinylidene fluoride, polyimide, polyamide imide, aramid, polyacrylic acid, lithium polyacrylate, and carboxymethyl cellulose. Illustrative example of the synthetic rubber includes a styrene butadiene rubber, a fluorinated rubber, and ethylene propylene diene.

As to the negative electrode conductive assistant, for example, any one or more of carbon materials such as a carbon black, an acetylene black, a graphite, a Ketjen black, a carbon nanotube, and a carbon nanofiber can be used.

The negative electrode active material layer is formed, for example, by a coating method. The coating method is the method in which the negative electrode active material particle, the binder, etc. as well as, if necessary, the conductivity assistant and the carbon material are mixed, the resulting mixture is dispersed in an organic solvent or water, and then this is applied.

### [Method for Producing the Negative Electrode]

The negative electrode can be produced, for example, by the procedure shown below. At first, the method for producing the negative electrode active material to be used for the negative electrode will be explained. In this method, first, the negative electrode active material particle is produced by a step of compounding the silicon compound particle including the silicon compound (SiOₓ: 0.5≤x≤1.6) with carbon and a step of inserting lithium into the silicon compound particle thus compounded with carbon so as to include at least any one or more of Li₂SiO₃ and Li₄SiO₄ in the silicon compound particle thereby obtaining the negative electrode active material particles. Next, from the negative electrode active material including the negative electrode active material particle thus obtained, the negative electrode active material which includes 2% by mass or less of silicon dioxide particle and includes a silicon dioxide-carbon composite secondary particle including a plurality of the silicon dioxide particles and carbon is selected thereby producing the negative electrode active material, wherein the composite secondary particle includes a lithium compound in at least part of a portion other than a silicon dioxide or a silicon compound (SiOₓ: 0.5≤x≤1.6) in the composite secondary particle. By so doing, the negative electrode active material having not only a high capacity but also excellent cycle characteristic and initial charge and discharge characteristics upon using it as the negative electrode active material for the lithium ion secondary battery, can be produced.

More specifically, the negative electrode active material can be produced as follows. First, a raw material capable of generating a silicon oxide gas is heated under reduced pressure in the presence of an inert gas in the temperature range of 900 to 1600° C., so that the silicon oxide gas is generated. Considering the presence of oxygen on surface of the metal silicon powder and minute oxygen in a reaction furnace, the mixing molar ratio preferably satisfies the relationship of 0.8<metal silicon powder/silicon dioxide powder<1.3.

The generated silicon oxide gas is solidified on an adsorbing plate and deposited thereon. Next, the deposited silicon oxide is taken out under the state that the temperature inside the reaction furnace is dropped to 100° C. or lower; and then, it is crushed and pulverized by using a ball mill, a jet mill, or the like. In this way, the silicon compound particle can be prepared. Meanwhile, the Si crystallite in the silicon compound particle can be controlled by changing the vaporization temperature, or a heat treatment after the generation thereof.

Next, a layer of the carbon material is formed on surface layer of the silicon compound particle so as to compound the silicon compound with carbon. As to the formation method of the carbon material layer, a thermal decomposition CVD method is preferable. A method for forming the carbon material layer by the thermal decomposition CVD method will be explained.

First, the silicon compound particle is set in a furnace. Next, a hydrocarbon gas is introduced into the furnace, and then, the temperature inside the furnace is raised. The decomposition temperature is not particularly restricted; however, 1200° C. or lower is preferable, while more preferably 950° C. or lower. When the decomposition temperature of 1200° C. or lower is used, the active material particle can be suppressed from unintended disproportionation. After the temperature inside the furnace is raised to a predetermined temperature, the carbon layer is formed on surface of the silicon compound particle. The hydrocarbon gas used as the raw material of the carbon material is not particularly restricted; however, in the CₙHₙ composition, n≤3 is preferable. When n≤3, not only the production cost thereof can be made low, but also physical properties of the decomposition products can be made excellent. With regard to the furnace to carry out the thermal decomposition CVD, there is no particular restriction; however, use of a rotary kiln is preferable. In the rotary kiln, by rotation of the furnace tube the silicon compound particles therein are mixed and stirred, so that the carbon layer which is highly uniform can be formed on surface of the silicon compound particle.

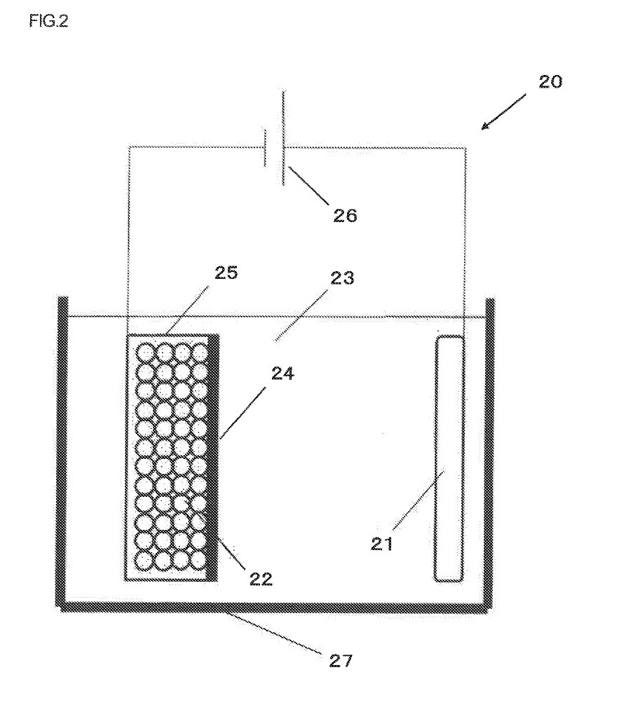

Next, reformation is carried out by inserting Li into the negative electrode active material particle, which includes the silicon active material particle formed in the way as described above, in such a way that at least any one or more of Li₂SiO₃ and Li₄SiO₄ is included therein. It is preferable that insertion of Li is carried out electrochemically. At this time, the produced materials in the bulk can be controlled by controlling the insertion electric potential and release electric potential, as well as by changing current density, bath temperature, and number of insertion and release. The apparatus structure is not particularly restricted; however, for example, by using an inner-bulk reforming apparatus 20 illustrated by FIG. 2, reformation in the bulk can be carried. The inner-bulk reforming apparatus 20 comprises a bath 27 which is filled with an organic solvent 23, a positive electrode 21 (lithium source) which is disposed in the bath 27 and connected to one side of a power source 26, a powder storage vessel 25 which is disposed in the bath 27 and connected to the other side of the power source 26 while storing silicon oxide powder 22 therein, and a separator 24 which is disposed between the positive electrode 21 and the powder storage vessel 25. After reformation by insertion of Li, a method such as cleaning with an alcohol, an alkali water, a weak acid, or pure water can be used.

Alternatively, Li may be inserted into the negative electrode active material particle by a thermal doping method. In this case, for example, reformation can be made by mixing the negative electrode active material particle with LiH powder or with Li powder, which is followed by heating the resulting mixture under a non-oxidizing atmosphere. As to the non-oxidizing atmosphere, for example, an Ar atmosphere or the like can be used. More specifically, first, under the Ar atmosphere, the silicon oxide powder is mixed well with the LiH powder or with the Li powder, and then the resulting mixture is sealed in a vessel; and then, the whole vessel is stirred so as to make the mixture uniform. Thereafter, heating thereof is carried out at 700 to 750° C. to carry out reformation. In this case, in order to release Li from the silicon compound, the powder after heating is sufficiently cooled down, and then, a method such as washing with an alcohol, an alkali water, a weak acid, or pure water may be used.

Next, from the negative electrode active material including the negative electrode active material particles inserted with Li, the negative electrode active material which includes 2% by mass or less of silicon dioxide particle, and includes a silicon dioxide-carbon composite secondary particle including a plurality of the silicon dioxide particles and carbon is selected, wherein the composite secondary particle includes a lithium compound in at least part of a portion other than a silicon dioxide or a silicon compound (SiOₓ: 0.5≤x≤1.6) in the composite secondary particle. Meanwhile, selection of the negative electrode active material particles is not needed every time when the negative electrode active material is produced. Once the production condition with which the negative electrode active material includes 2% by mass or less of silicon dioxide particle, and includes the composite secondary particle is found and selected, thereafter, the negative electrode active material can be produced with the same condition as the selected condition.

Meanwhile, each composition of the negative electrode active material of the present invention can be controlled, for example, as follows. Content of the silicon dioxide particle in the negative electrode active material can be controlled by changing the heating temperature and pressure at the time of generating silicon oxide. Presence or absence of the composite secondary particle can be controlled by controlling the gas concentration, temperature, and pressure at the time of CVD. That the composite secondary particle is made to include a lithium compound in at least part of the composite secondary particle other than the portions of the silicon dioxide or the silicon compound can be controlled by controlling the condition at the time when lithium is inserted electrochemically or thermally as mentioned above. Presence or absence of the silicon compound in the composite secondary particle can be controlled by changing the crushing condition so as to change the particle-size distribution of the silicon compound particle. The size of the composite secondary particle can be controlled by changing the stirring condition (angle as well as number of rotation of the rotary kiln) during the time of the thermal decomposition CVD. The carbon content in the composite secondary particle can be controlled by changing the gas and temperature condition at the time of the thermal decomposition CVD. The relationship between Xₛ and X can be controlled by changing the oxygen concentration in the cooling atmosphere after the CVD process.

The negative electrode active material prepared in the way as mentioned above is mixed with other materials such as the negative electrode binder and the conductivity assistant to obtain the negative electrode mixture, which is followed by addition of an organic solvent, water, or the like to obtain a slurry. Next, this slurry is applied onto the negative electrode current collector surface and then dried to form the negative electrode active material layer. At this time, a hot press or the like may be carried out as needed. In the way as mentioned above, the negative electrode can be produced.

### <Lithium Ion Secondary Battery>

Next, the lithium ion secondary battery of the present invention will be explained. The lithium ion secondary battery of the present invention uses the negative electrode including the negative electrode active material of the present invention. Here, the laminate film type lithium ion secondary batter is taken as the specific example thereof.

### [Composition of the Laminate Film Type Secondary Battery]

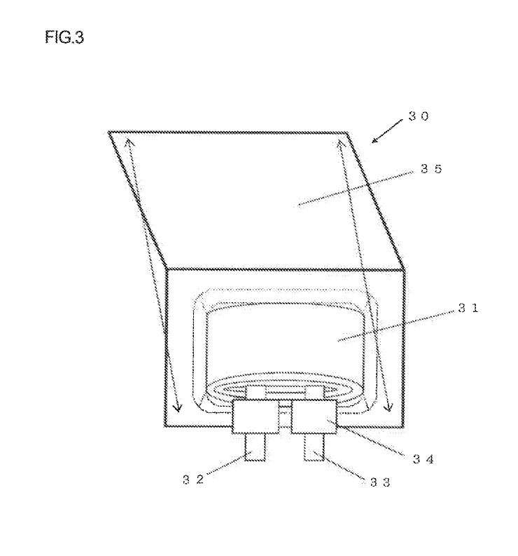

A laminate film type secondary battery 30 shown in FIG. 3 has a rolled electrode body 31 stored inside an exterior member 35 mainly having a sheet form. This rolled body has a separator between a positive electrode and a negative electrode, and they are rolled. Alternatively, there is a case that a stacked body having the separator between the positive electrode and the negative electrode is stored. In the both electrode bodies, a positive electrode lead 32 is attached to the positive electrode, and a negative electrode lead 33 is attached to the negative electrode. The outermost periphery of the electrode body is protected by a protection tape.

The positive electrode and negative electrode leads are derived, for example, in one direction from inside to outside of the exterior member. The positive electrode lead 32 is formed of a conductive material such as, for example, aluminum; and the negative electrode lead 33 is formed of a conductive material such as nickel or copper.

The exterior member 35 is a laminate film in which, for example, a melt-adhering layer, a metal layer, and a surface protection layer are stacked in this order. In the laminate film, the melt-adhering layers are melt-adhered or adhered by an adhesive to each other in the outer peripheral portions in the melt-adhering layers of two films such that the melt-adhering layer may face to the electrode body. For example, the melt-adhering portion is a film of polyethylene or polypropylene, and a metal portion is an aluminum foil or the like. The protection layer is, for example, nylon.

Between the exterior member 35 and the positive electrode and negative electrode leads, an adhesion film 34 is inserted in order to prevent an outside air from invading. The material thereof is, for example, polyethylene, polypropylene, or a polyolefin resin.

### [Positive Electrode]

The positive electrode has a positive electrode active material layer on both or one surface of the positive electrode current collector, for example, in the same way as the negative electrode 10 of FIG. 1. The positive electrode current collector is formed of a conductive material such as, for example, aluminum. The positive electrode active material layer includes one, or two or more of positive electrode materials which can adsorb and release a lithium ion, and may include other material such as a binder, a conductivity assistant, or a dispersant, depending on the design thereof. In this case, details of the binder and the conductivity assistant are, for example, the same as those of the negative electrode binder and the negative electrode conductivity assistant as described before.

The positive electrode material is preferably a lithium-containing compound. Illustrative example of the lithium-containing compound includes a composite oxide formed of lithium and a transition metal element, or a phosphoric acid compound having lithium and a transition metal element. Among these positive electrode materials, a compound having at least any one or more of nickel, iron, manganese, and cobalt is preferable. These positive electrode materials are expressed by the chemical formula such as, for example, LiₓM1O₂ or Li_{y}M2PO₄. In the formulae, M1 and M2 represent at least any one or more of transition metal elements. The values of x and y are different in the charge or discharge state of the battery; but they are generally 0.05≤x≤1.10 and 0.05≤y≤1.10.

Illustrative example of the composite oxide formed of lithium and a transition metal element includes a lithium cobalt composite oxide (LiₓCoO₂) and a lithium nickel composite oxide (LiₓNiO₂). Illustrative example of the phosphoric acid compound having lithium and a transition metal element includes a lithium iron phosphate compound (LiFePO₄) and a lithium iron manganese phosphate compound (LiFe₁₋ᵤMnᵤPO₄ (0<u<1)). When these positive electrode materials are used, not only a high battery capacity but also an excellent cycle characteristic can be obtained.

### [Negative Electrode]

The negative electrode has the same composition as that of the negative electrode for the non-aqueous electrolyte secondary battery shown in FIG. 1, whereby having, for example, the negative electrode active material layer on both surfaces of the current collector.

In this negative electrode, it is preferable that the negative electrode charge capacity is greater than the electric capacity (charge capacity as the battery) obtained from the positive electrode active material. By so doing, deposition of the lithium metal on the negative electrode can be suppressed.

The positive electrode active material layer is arranged on part of both surfaces of the positive electrode current collector; and also, the negative electrode active material layer is arranged on part of both surfaces of the negative electrode current collector. In this case, for example, in the negative electrode active material layer formed on the negative electrode current collector, there is an area in which there is no positive electrode active material layer facing thereto. This is because a stable battery design can be performed.

In the area in which the negative electrode active material layer does not face to the positive electrode active material layer, there is hardly an influence of charge and discharge. Because of this, the state of the negative electrode active material layer immediately after formation thereof can be maintained as it is. Accordingly, the composition, etc. of the negative electrode active material can be accurately and reproducibly investigated without depending on charge and discharge.

### [Separator]

The separator separates between the negative electrode and the positive electrode, and allows for the lithium ion to pass through it while preventing the short circuit due to contacts of both electrodes. This separator is formed of, for example, a synthetic resin or a porous film formed of ceramic, wherein it may have a stacked structure of two or more porous films. Illustrative example of the synthetic resin includes polytetrafluoroethylene, polypropylene, and polyethylene.

### [Electrolyte Solution]

In at least part of the active material layer or in the separator, a liquid electrolyte (electrolyte solution) is impregnated. In this electrolyte solution, an electrolyte salt is dissolved in a solvent, wherein other material such as an additive may be included.

As to the solvent, for example, a non-aqueous solvent can be used. Illustrative example of the non-aqueous solvent includes ethylene carbonate, propylene carbonate, butylene carbonate, dimethyl carbonate, diethyl carbonate, ethyl methyl carbonate, methyl propyl carbonate, 1,2-dimethoxyethane, and tetrahydrofuran. Among them, at least any one or more of ethylene carbonate, propylene carbonate, dimethyl carbonate, diethyl carbonate, and ethyl methyl carbonate is preferably used. In this case, when a high viscous solvent such as ethylene carbonate or propylene carbonate is combined with a low viscous solvent such as dimethyl carbonate, ethyl methyl carbonate, or diethyl carbonate, dissociation of the electrolyte salt as well as ion mobility can be improved.

When an alloy-based negative electrode is used, especially as the solvent, it is preferable to include at least any one of a halogenated chain carbonate ester or a halogenated cyclic carbonate ester. With this, during charging and discharging, especially during charging, a stable film is formed on surface of the negative electrode active material. Meanwhile, the halogenated chain carbonate ester is a chain carbonate ester having a halogen as the constituent element thereof (at least one hydrogen atom thereof is substituted with a halogen). The halogenated cyclic carbonate ester is a cyclic carbonate ester having a halogen as the constituent element thereof (at least one hydrogen atom thereof is substituted with a halogen).

The halogen is not particularly restricted; however, fluorine is preferable. This is because a better film than the film containing other halogen is formed. In addition, number of the halogen is larger the better. This is because the obtained film is more stable so that the decomposition reaction of the electrolyte solution can be suppressed.

Illustrative example of the halogenated chain carbonate ester includes fluoromethyl methyl carbonate and difluoromethyl methyl carbonate. Illustrative example of the halogenated cyclic carbonate ester includes 4-fluoro-1,3-dioxolane-2-one and 4,5-difluoro-1,3-dioxolane-2-one.

It is preferable to include as a solvent additive a cyclic carbonate ester having an unsaturated carbon bond. This is because a stable film is formed on surface of the negative electrode during charging and discharging, so that the decomposition reaction of the electrolyte solution can be suppressed. Illustrative example of the cyclic carbonate ester having an unsaturated carbon bond includes vinylene carbonate and vinyl ethylene carbonate.

In addition, it is preferable to include a sultone (cyclic sulfonate ester) as the solvent additive. This is because a chemical stability of the battery can be improved. Illustrative example of the sultone includes propane sultone and propene sultone.

In addition, it is preferable that the solvent includes an acid anhydride. This is because a chemical stability of the electrolyte solution can be improved. Illustrative example of the acid anhydride includes propane disulfonic anhydride.

The electrolyte solution can include any one or more of a light metal salt such as, for example, a lithium salt. Illustrative example of the lithium salt includes lithium hexafluorophosphate (LiPF₆) and lithium terafluoroborate (LiBF₄).

Content of the electrolyte salt is preferably 0.5 mol/kg or more and 2.5 mol/kg or less relative to the solvent. This is because a high ionic conductivity can be obtained.

### [Method for Producing the Laminate Type Secondary Battery]

At first, the positive electrode is produced by using the positive electrode material as mentioned above. First, the positive electrode active material is mixed, as needed, with a binder, a conductivity assistant, etc. to obtain the positive electrode material mix, which is then dispersed into an organic solvent to obtain a slurry of the positive electrode mixture. Next, the mixture slurry is applied onto the positive electrode current collector by using a coating apparatus such as a die coater having a knife roll or a die head, and then, it is dried by a hot air to obtain the positive electrode active material layer. Finally, the positive electrode active material layer is press molded by a roll press machine or the like. At this time, heating or repetition of plural times may be made. Then, the positive electrode active material layer is formed on both surfaces of the positive electrode current collector. At this time, the active material coating length of the both surface portions may be off.

Next, by following the same operation procedure as production of the negative electrode for the non-aqueous secondary battery, the negative electrode active material layer is formed on the negative electrode current collector to obtain the negative electrode.

Upon producing the positive electrode and the negative electrode, the active material layer of each is formed on both surfaces of the positive electrode and negative electrode current collectors. At this time, the active material coating length of the both surface portions may be off in any of the electrodes (see, FIG. 1).

Next, the electrolyte solution is prepared. Next, by an ultrasonic welding or the like, the positive electrode lead is attached to the positive electrode current collector, and also the negative electrode lead is attached to the negative electrode current collector. Next, the positive electrode and the negative electrode are stacked or rolled via the separator to obtain the rolled electrode body, which is then followed by adhesion of the protection film on the outermost peripheral portion thereof. Next, the rolled body is molded so as to be a flat form. Next, after the rolled electrode body is sandwiched between the exterior members in a film form and folded, the insulation portions of the exterior members are adhered to each other by a thermal adhesion method so as to seal the rolled electrode body with an open state only in one direction. The adhesion films are inserted between the exterior member and the positive electrode lead and between the exterior member and the negative electrode lead. After the predetermined amount of the electrolyte solution previously prepared is charged from the open portion, vacuum impregnation is carried out. After the impregnation, the open portion is adhered by a vacuum thermal adhesion method. In the way as mentioned above, the laminate film type lithium ion secondary batter can be produced.

### EXAMPLES

Hereinafter, the present invention will be explained more specifically by showing Examples and Comparative Examples; but the present invention is not limited thereto.

### Example 1-1

According to the following procedure, the laminate film type lithium ion secondary batter 30 shown in FIG. 3 was produced.

First, the positive electrode was prepared. The positive electrode mixture was prepared by mixing 95% by mass of LiNi_{0.7}Co_{0.25}Al_{0.05}, which is a lithium nickel cobalt composite oxide as the positive electrode active material, 2.5% by mass of the positive electrode conductivity assistant, and 2.5% by mass of the positive electrode binder (polyvinylidene fluoride: PVDF). Next, the positive electrode mixture was dispersed into the organic solvent (N-methyl-2-pyrrolidone; NMP) to obtain a slurry in a paste form. Next, by using a coating apparatus having a die head, the slurry was applied onto both surfaces of the positive electrode current collector, and then, it was dried with a hot air drying equipment. At this time, the positive electrode current collector having a thickness of 15 μm was used. Finally, the press molding thereof was carried out by a roll press.

Next, the negative electrode was prepared. The negative electrode active material was prepared as follows. A mixture of metal silicon and silicon dioxide was introduced as the raw material into a reaction furnace, and the mixture was vaporized in an atmosphere with the vacuum degree of 10 Pa so as to be deposited onto an adsorbing plate. After the deposited material was sufficiently cooled down, it was taken out and crushed by a ball mill. The x value of SiOₓ of the silicon compound particle thus obtained was 0.5. Next, the particle diameter of the silicon compound particle was adjusted by classification. After adjustment of the particle diameter, in order to obtain the carbon coating film and the composite secondary particle, the thermal decomposition CVD was carried out. As the equipment for the thermal decomposition CVD, a rotary kiln provided with a reaction gas inlet port, a carrier gas inlet port, and a rotary cylinder furnace with the inner diameter of 200 mm and the length of 3 m was prepared. At this time, 1 degree was chosen as the angle of inclination of the furnace in the longitudinal direction. In the way as described above, the negative electrode active material particles was prepared.

Next, the negative electrode active material particles thus obtained was reformed by electrochemically inserting lithium thereinto. Specifically, by using the inner-bulk reforming apparatus 20, the inner-bulk reformation was carried out in the 1:1 mixed solvent of propylene carbonate and ethylene carbonate (this mixed solvent includes 1.3 mol/kg of the electrolyte salt) by using the electric potential/current control plus partial release after Li insertion method. Here, the electric potential/current control plus partial release after Li insertion method is the method that after Li is inserted into the bulk with controlling the electric potential and current supplied to the lithium source 21, part of lithium thus inserted is released with controlling the electric potential and current by using the inner-bulk reforming apparatus 20 shown in FIG. 2. The negative electrode active material particle that was reformed by inserting lithium was dried under a carbon dioxide atmosphere, as needed.

Next, the negative electrode active material thus prepared and the carbon-based active material were blended with the mass ratio of 1:9 to obtain the mixed negative electrode active material. Here, as to the carbon-based active material, a mixture of natural graphite and artificial graphite covered with a pitch layer with the mass ratio of 5:5 was used. The median diameter of the carbon-based active material was 20 μm.

Next, the mixed negative electrode active material thus obtained, the conductivity assistant 1 (carbon nanotube; CNT), the conductivity assistant 2 (carbon microparticle with the median diameter of about 50 nm), the styrene butadiene rubber (styrene-butadiene copolymer; hereinafter, this is referred to as SBR), and the carboxymethyl cellulose (hereinafter, this is referred to as CMC) were mixed with the dry mass ratio of 92.5:1:1:2.5:3; and then, the resulting mixture was diluted with pure water to obtain the negative electrode mixture slurry. Meanwhile, SBR and CMC mentioned above are the negative electrode binders.

As to the negative electrode current collector, an electrolysis copper foil with the thickness of 15 μm was used. In this electrolysis copper foil, carbon and sulfur were included each with the concentration of 70 ppm by mass. Finally, the negative electrode mixture slurry was applied onto the negative electrode current collector; and then, it was dried under vacuum atmosphere at 100° C. for 1 hour. The deposition amount of the negative electrode active material layer per a unit area in one surface of the negative electrode after drying was 5 mg/cm² (this is also referred to as the area density).

Next, after the solvents (4-fluoro-1,3-dioxolane-2-one (FEC), ethylene carbonate (EC), and dimethyl carbonate (DMC)) were mixed, the electrolyte salt (lithium hexafluorophosphate: LiPF₆) was dissolved into this solvent mixture to obtain the electrolyte solution. In this case, the solvent composition of FEC:EC:DMC=10:20:70 as the volume ratio was used while the content of the electrolyte salt was 1.2 mol/kg relative to the solvent.

Next, the secondary battery was fabricated as follows. First, an aluminum lead was attached to one end of the positive electrode current collector with an ultrasonic welding, and also a nickel lead was welded to one end of the negative electrode current collector. Next, the positive electrode, the separator, the negative electrode, and the separator were stacked in this order, and then, the laminate thus formed was rolled in the longitude direction to obtain the rolled electrode body. The roll end portion thereof was fixed by a PET protection tape. As to the separator, a laminate film formed by sandwiching the film mainly comprising porous polyethylene with the films mainly comprising porous polypropylene was used (thickness of 12 μm). Next, after the electrode body was sandwiched by the exterior members, the outer peripheral portions thereof except for one side were thermally adhered to each other so as to store the electrode body therein. As to the exterior member, the aluminum laminate film formed by stacking a nylon film, an aluminum foil, and a polypropylene film was used. Next, from the open portion, the prepared electrolyte solution was charged; and after impregnation was carried out under vacuum atmosphere, the open portion was sealed by thermal adhesion.

The cycle characteristic and the first time charge and discharge characteristics of the secondary battery thus fabricated were evaluated.

The cycle characteristic was investigated as follows. First, in order to stabilize the battery, two cycles of charge and discharge were carried out at the atmospheric temperature of 25° C. with 0.2 C; and the discharge capacity at the second cycle was measured. Next, the charge and discharge were carried out until the total cycle number reached 499 cycles, wherein the discharge capacity was measured at each cycle. Finally, the discharge capacity at the 500^{th} cycle obtained with the 0.2 C charge and discharge was divided with the discharge capacity at the second cycle to calculate the capacity retention rate (hereinafter, this is sometimes referred to as simply “retention rate”). In the normal cycle, namely, from the 3^{rd} cycle to the 499^{th} cycle, the charge and discharge were performed with the 0.7 C charge and the 0.5 C discharge.

To study the first time charge and discharge characteristics, the first time efficiency (hereinafter, this is sometimes referred to as the initial efficiency), the first efficiency was calculated from the equation, first time efficiency (%)=(first time discharge capacity/first time charge capacity)×100. The atmospheric temperature was as same as that used in the investigation of the cycle characteristic.

### Example 1-2 to Example 1-3 and Comparative Examples 1-1 and 1-2

The secondary battery was fabricated in the same way as Example 1-1, except that the oxygen amount in the bulk of the silicon compound was controlled. In this case, the oxygen amount was controlled by changing the ratio of metal silicon to silicon dioxide in the silicon compound raw material as well as by changing the heating temperature. The “x” values of the silicon compounds expressed by SiOₓ in Examples 1-1 to 1-3 and Comparative Examples 1-1 and 1-2 are shown in Table 1.

At this time, the silicon-based active material particles of Examples 1-1 to 1-3 and Comparative Examples 1-1 and 1-2 had the following properties. Inside the silicon compound particle in the negative electrode active material particle, Li₂SiO₃ and Li₄SiO₄ were included. The median diameter D₅₀ of the negative electrode active material particle was 4.0 m. In the silicon compound, the half-value width value (2θ) of the diffraction peak attributable to the Si(111) crystal plane obtained from the X-ray diffraction was 2.257°, and the crystallite's size attributable to the Si(111) crystal plane was 3.77 nm.

In all of Examples and Comparative Examples shown above, the peaks in the Si and lithium silicate regions given as the chemical shift value of −60 ppm to −95 ppm were appeared in the ²⁹Si-MAS-NMR spectrum. In all of Examples and Comparative Examples shown above, the relationship A>B was satisfied, wherein A is a maximum peak strength value in the Si and Li silicate regions given as the chemical shift value of −60 ppm to −95 ppm and B is a peak strength value in the SiO₂ region given as a chemical shift value of −96 ppm to −150 ppm, these values being obtained from a ²⁹Si-MAS-NMR spectrum.

The average thickness of the carbon coating film on surface of the negative electrode active material particle was 100 nm.

The negative electrode active material included 0.7% by mass of the silicon dioxide particle, and includes the composite secondary particle including a plurality of silicon oxide particles and carbon, wherein the composite secondary particle was covered with a lithium compound. The composite secondary particle further included the silicon compound particle including the silicon compound (SiOₓ: 0.5≤x≤1.6), wherein the average particle diameter of the composite secondary particle was 7 μm. The carbon ratio in this composite secondary particle was 70 at %.

In the silicon compound particle included in the composite secondary particle, Xₛ and X were in the relationship of Xₛ<X, wherein Xₛ is defined as the oxygen/silicon molar ratio in a region of 5 nm or less from surface of the silicon compound particle (surface region) and X is defined as the oxygen/silicon molar ratio in a region of 100 nm or more from surface of the silicon compound particle (inside region).

From the negative electrode prepared as described above and the counter lithium, a coin battery type test cell with the size of 2032 was fabricated; and the discharge behavior thereof was evaluated. More specifically, first, the constant current and constant voltage charge was carried out to 0 V in the counter Li; and when the current density reached 0.05 mA/cm², the charge was stopped. Thereafter, the constant current discharge was carried out to 1.2 V. The current density at this time was 0.2 mA/cm². This charge and discharge was repeated for 30 times; and from the data in each charge and discharge, the graph was plotted wherein the capacity change rate (dQ/dV) is shown in the vertical axis and the voltage (V) is shown in the horizontal axis so as to confirm whether or not a peak is obtained in the range of 0.4 to 0.55 (V). As a result, in Comparative Example 1 in which x in SiOₓ is less than 0.5, the above-mentioned peak could not be obtained. In other Examples and Comparative Examples, the peak could be obtained in the charge and discharge within 30 times; and moreover, the peak could be obtained in every charge and discharge from the charge and discharge in which the peak was observed for the first time till the 30^{th} charge and discharge.

Evaluation results of Examples 1-1 to 1-3 and Comparative Examples 1-1 and 1-2 are shown in Table 1.

TABLE 1

| | | Capacity | Initial |
|---|---|---|---|
| | | retention | efficiency |
| | x | rate (%) | (%) |
| Comparative | 0.3 | 46 | 88.3 |
| Example 1-1 | | | |
| Example 1-1 | 0.5 | 80.9 | 85.8 |
| Example 1-2 | 1 | 81.3 | 86.7 |
| Example 1-3 | 1.6 | 81.0 | 85.9 |
| Comparative | 1.8 | — | — |
| Example 1-2 | | | |

SiOₓ: D₅₀=4 μm,
graphite: (natural graphite:artificial graphite=5:5), D₅₀=20 μm,
SiOₓ ratio: 10% by mass, Li₂SiO₃ and Li₄SiO₄,
carbon coating film: average thickness 100 nm,
half-value width: 2.257°, crystallite: 3.77 nm,
reformation method: electrochemically, A>B,
content of silicon dioxide particle: 0.7% by mass,
presence or absence of composite secondary particle: presence,
inclusion of SiOₓ in composite secondary particle: yes,
average particle diameter of composite secondary particle: 7 μm,
cover of composite secondary particle with lithium: yes,
carbon content in composite secondary particle: 70 at %, Xₛ<X

As can be seen in Table 1, in the silicon compound represented by SiOₓ, when the value of x is outside of 0.5≤x≤1.6, the battery characteristics were deteriorated. For example, as can be seen in Comparative Example 1-1, when there was no sufficient oxygen (x=0.3), the capacity retention rate was remarkably deteriorated even though the first efficiency was increased. On the other hand, as can be seen in Comparative Example 1-2, when there is much oxygen (x=1.8), the conductivity was decreased so low that substantially the capacity of the silicon oxide did not appear; and thus, the evaluation was stopped.

### Example 2-1 and Example 2-2

The secondary battery was fabricated with the same condition as Example 1-2 except that the lithium silicates included inside the silicon compound particle were changed as shown in Table 2; and then, the cycle characteristic and the initial efficiency were evaluated. Kind of the lithium silicate was controlled by changing the condition of the lithium insertion process by the oxidation and reduction method.

### Comparative Example 2-1

The secondary battery was fabricated with the same condition as Example 1-2 except that lithium was not inserted into the negative electrode active material particle; and then, the cycle characteristic and the initial efficiency were evaluated with the same condition as that of Example 1-2.

Evaluation results of Example 2-1, Example 2-2, and Comparative Example 2-1 are shown in Table 2.

TABLE 2

| | | Capacity | Initial |
|---|---|---|---|
| | Lithium | retention | efficiency |
| | silicate | rate (%) | (%) |
| Example 2-1 | Li₂SiO₃ | 80.8 | 85.4 |
| Example 2-2 | Li₄SiO₄ | 80.9 | 85.5 |
| Example 1-2 | Li₂SiO₃, | 81.3 | 86.7 |
| | Li₄SiO₄ | | |
| Comparative | — | 78.0 | 82.5 |
| Example 2-1 | | | |

SiOₓ: x=1, D₅₀=4 μm,
graphite: (natural graphite:artificial graphite=5:5), D₅₀=20 μm,
SiOₓ ratio: 10% by mass,
carbon coating film: average thickness 100 nm,
presence of dQ/dV peak: yes,
half-value width: 2.257°, crystallite: 3.77 nm,
reformation method: electrochemically, A>B,
content of silicon dioxide particle: 0.7% by mass, presence or absence of composite secondary particle: presence,
inclusion of SiOₓ in composite secondary particle: yes,
average particle diameter of composite secondary particle: 7 μm,
cover of composite secondary particle with lithium: yes,
carbon content in composite secondary particle: 70 at %, Xₛ<X

When the silicon compound included the stable lithium silicates such as Li₂SiO₃ and Li₄SiO₄, the capacity retention rate as well as the initial efficiency could be improved. Especially when both Li₂SiO₃ and Li₄SiO₄ were included, the cycle characteristic and the initial charge and discharge characteristics could be improved furthermore. On the other hand, in Comparative Example 2-1 in which reformation was not carried out thereby not including the lithium silicate, the cycle characteristic and the initial charge and discharge characteristics were deteriorated.

### Example 3-1 to Example 3-4, and Comparative Example 3-1 to Comparative Example 3-6

The secondary battery was fabricated with the same condition as Example 1-2 except that content of the silicon dioxide particle in the negative electrode active material was changed as shown in Table 3 and that presence or absence of the composite secondary particle was controlled; and then, the slurry stability, the cycle characteristic, and the initial efficiency were evaluated with the same condition as that of Example 1-2. Meanwhile, in Example 3-1 to Example 3-4 and Comparative Example 3-1, the negative electrode active material included the composited secondary particle including a plurality of silicon compound particles and carbon; and this composite secondary particle was covered with the lithium compound. This composite secondary particle further included the silicon compound particle including the silicon compound (SiOₓ: 0.5≤x≤1.6), and the average particle diameter of the composite secondary particle was 7 μm. The carbon rate in the composite secondary particle was 70 at %. Content of the silicon dioxide particle in the negative electrode active material was controlled by changing the heating temperature and pressure at the time of generating silicon oxide. Presence or absence of the composited secondary particle was controlled by adjusting the gas concentration, temperature, and pressure during the time of CVD.

Evaluation results of Example 3-1 to Example 3-4, and Comparative Example 3-1 to Comparative Example 3-6 are shown in Table 3.

TABLE 3

| | Content of | Composite | | |
|---|---|---|---|---|
| | silicon | secondary | | |
| | dioxide | particle; | Capacity | Initial |
| | particle | presence | retention | efficiency |
| | (% by mass) | or absence | rate (%) | (%) |
| Example 3-1 | 0.5 | Presence | 81.0 | 86.5 |
| Example 1-2 | 0.7 | Presence | 81.3 | 86.7 |
| Example 3-2 | 1.0 | Presence | 80.9 | 86.4 |
| Example 3-3 | 1.5 | Presence | 80.7 | 86.1 |
| Example 3-4 | 2.0 | Presence | 80.5 | 85.8 |
| Comparative | 2.2 | Presence | 75.2 | 83.5 |
| Example 3-1 | | | | |
| Comparative | 0.5 | Absence | 78.2 | 84.8 |
| Example 3-2 | | | | |
| Comparative | 0.7 | Absence | 77.8 | 84.5 |
| Example 3-3 | | | | |
| Comparative | 1.0 | Absence | 77.6 | 84.3 |
| Example 3-4 | | | | |
| Comparative | 1.5 | Absence | 77.3 | 84.1 |
| Example 3-5 | | | | |
| Comparative | 2.0 | Absence | 77.1 | 84.0 |
| Example 3-6 | | | | |

SiOₓ: x=1, D₅₀=4 μm,
graphite: (natural graphite:artificial graphite=5:5), D₅₀=20 μm,
SiOₓ ratio: 10% by mass, Li₂SiO₃ and Li₄SiO₄,
carbon coating film: average thickness 100 nm,
presence of dQ/dV peak: yes,
half-value width: 2.257°, crystallite: 3.77 nm,
reformation method: electrochemically, A>B, Xₛ<X

As can be seen in Table 3, in Examples 3-1 to 3-4 and Example 1-2 in which content of the silicon dioxide particle in the negative electrode active material was 2.0% by mass or less and the composited secondary particle was included, the cycle characteristic and the initial charge and discharge characteristics were improved as compared with those of Comparative Example 3-1 in which the composited secondary particle was included but content of the silicon dioxide particle in the negative electrode active material was more than 2.0% by mass and with those of Comparative Examples 3-2 to 3-6 in which content of the silicon oxide particle in the negative electrode active material was 2.0% by mass or less but the composited secondary particle was not included.

### Example 4-1

The secondary battery was fabricated with the same condition as Example 1-2 except that as shown in Table 4, the change was made such that the composite secondary particle did not include the silicon compound particle including the silicon compound (SiOx: 0.5≤x≤1.6); and then, the cycle characteristic and the initial efficiency were evaluated with the same condition as that of Example 1-2. Presence or absence of the silicon compound particle in the composite secondary particle was controlled by the crushing condition so as to change the particle-size distribution of the silicon compound particle.

### Example 4-2 to Example 4-6

The secondary battery was fabricated with the same condition as Example 1-2 except that the average particle diameter of the composite secondary particle was changed as shown in Table 4; and then, the cycle characteristic and the initial efficiency were evaluated with the same condition as that of Example 1-2. Size of the composite secondary particle was controlled by changing the stirring conditions (angle and rotation number of the rotary kiln) during the time of thermal decomposition CVD.

Evaluation results of Examples 4-1 to Examples 4-6 are shown in Table 4.

TABLE 4

| | | Average | | |
|---|---|---|---|---|
| | SiOx in | particle | | |
| | composite | diameter of | | |
| | secondary | composite | | |
| | particle; | secondary | Capacity | Initial |
| | presence | particle | retention | efficiency |
| | or absence | (μm) | rate (%) | (%) |
| Example 4-1 | Absence | 7 | 80.1 | 86.6 |
| Example 4-2 | Presence | 0.5 | 80.2 | 86.6 |
| Example 4-3 | Presence | 1 | 80.7 | 86.7 |
| Example 4-4 | Presence | 5 | 81.0 | 86.7 |
| Example 1-2 | Presence | 7 | 81.3 | 86.7 |
| Example 4-5 | Presence | 15 | 81.0 | 86.6 |
| Example 4-6 | Presence | 20 | 80.0 | 86.5 |

SiOₓ: x=1, D₅₀=4 μm,
graphite: (natural graphite:artificial graphite=5:5), D₅₀=20 μm,
SiOₓ ratio: 10% by mass, Li₂SiO₃ and Li₄SiO₄,
carbon coating film: average thickness 100 nm,
presence of dQ/dV peak; yes,
half-value width: 2.257°, crystallite: 3.77 nm,
reformation method: electrochemically, A>B,
content of silicon dioxide particle: 0.7% by mass, presence or absence of composite secondary particle: presence,
average particle diameter of composite secondary particle: 15 μm,
cover of composite secondary particle with lithium: yes,
carbon content in composite secondary particle: 70 at %, Xₛ<X

As can be seen in Table 4, in Example 1-2 and Examples 4-3 to 4-5 in which the composite secondary particle included the silicon compound particle and the average particle diameter of the composite secondary particle was 1 μm or more and 15 μm or less, a more excellent cycle characteristic could be obtained as compared with Example 4-1 in which the average particle diameter of the composite secondary particle was 1 m or more and 15 μm or less but the composite secondary particle did not include the silicon compound particle, or with Examples 4-2 and 4-6 in which the composite secondary particle included the silicon compound particle but the average particle diameter of the composite secondary particle was outside of the above-mentioned range.

### Example 5-1 to Example 5-3

The secondary battery was fabricated with the same condition as Example 1-2 except that the carbon content in the composite secondary particle was changed as shown in Table 5; and then, the cycle characteristic and the initial efficiency were evaluated with the same condition as that of Example 1-2. The carbon content in the composite secondary particle was controlled by changing the kind of gas and temperature condition during the thermal decomposition CVD.

Evaluation results of Example 5-1 to Example 5-3 are shown in Table 5.

TABLE 5

| | Carbon | | |
|---|---|---|---|
| | content in | | |
| | composite | | |
| | secondary | Capacity | Initial |
| | particle | retention | efficiency |
| | (at %) | rate (%) | (%) |
| Example 5-1 | 80 | 81.6 | 86.9 |
| Example 1-2 | 70 | 81.3 | 86.7 |
| Example 5-2 | 60 | 81.0 | 86.5 |
| Example 5-3 | 50 | 80.0 | 85.1 |

SiOₓ: x=1, D₅₀=4 μm,
graphite: (natural graphite:artificial graphite=5:5), D₅₀=20 μm,
SiO_{X} ratio: 10% by mass, Li₂SiO₃ and Li₄SiO₄,
carbon coating film: average thickness 100 nm,
presence of dQ/dV peak: yes,
half-value width: 2.2570, crystallite: 3.77 nm,
reformation method: electrochemically, A>B,
content of silicon dioxide particle: 0.7% by mass,
presence or absence of composite secondary particle: presence,
inclusion of SiOₓ in composite secondary particle: yes,
average particle diameter of composite secondary particle: 7 μm,
cover of composite secondary particle with lithium: yes, Xₛ<X

As can be seen in Table 5, when the carbon content in the composite secondary particle was 60 at % or more, the cycle characteristic and the initial charge and discharge characteristics could be improved furthermore.

### Example 6-1

The secondary battery was fabricated with the same condition as Example 1-2 except that in the silicon compound particle included in the composite secondary particle, the relationship between Xₛ and X was changed as shown in Table 6, wherein Xₛ is defined as the oxygen/silicon molar ratio in the region of 5 nm or less from surface of the silicon compound particle (surface region) and X is defined as the oxygen/silicon molar ratio in the region of 100 nm or more from surface of the silicon compound particle (inside region); and then, the cycle characteristic and the first time efficiency were evaluated with the same condition as that of Example 1-2. The relationship between Xₛ and X was controlled by changing the oxygen concentration in the cooling atmosphere after the CVD process.

Evaluation results of Example 6-1 are shown in Table 6.

TABLE 6

| | Relationship | Capacity | Initial |
|---|---|---|---|
| | between Xs | retention | efficiency |
| | and X | rate (%) | (%) |
| Example 6-1 | Xs > X | 80.5 | 86.6 |
| Example 1-2 | Xs < X | 81.3 | 86.7 |

SiOₓ: x=1, D₅₀=4 μm,
graphite: (natural graphite:artificial graphite=5:5), D₅₀=20 μm,
SiOₓ ratio: 10% by mass, Li₂SiO₃ and Li₄SiO₄,
carbon coating film: average thickness 100 nm,
presence of dQ/dV peak: yes,
half-value width: 2.257°, crystallite: 3.77 nm,
reformation method: electrochemically, A>B,
content of silicon dioxide particle: 0.7% by mass, presence or absence of composite secondary particle: presence,

inclusion of SiOₓ in composite secondary particle: yes, average particle diameter of composite secondary particle: 7 μm,

cover of composite secondary particle with lithium: yes,
carbon content in composite secondary particle: 70 at %

As can be seen in Table 6, in Example 1-2 in which the relationship between Xₛ and X satisfies “Xₛ<X”, the cycle characteristic could be improved furthermore as compared with Example 6-1 in which the relationship between Xₛ and X is “Xₛ>X”.

### Examples 7-1 to 7-9

The secondary battery was fabricated with the same condition as Example 1-2 except that the crystallinity of the Si crystallite in the silicon compound particle was changed as shown in Table 7; and then, the cycle characteristic and the first time efficiency were evaluated with the same condition as that of Example 1-2. Meanwhile, the crystallinity of the Si crystallite in the silicon compound particle can be controlled by changing the vaporization temperature of the raw materials or the heat treatment after formation of the silicon compound particle. In Example 6-9, the half-value width is calculated to be 20° or more; however, this is a result of fitting by using an analysis software, so that a peak is not substantially obtained. Accordingly, it can be said that the silicon region in the silicon compound particle in Example 6-9 is substantially amorphous.

Evaluation results of Examples 7-1 to 7-9 are shown in Table 7.

TABLE 7

| | Half- | | | |
|---|---|---|---|---|
| | value | Si(111) | Capacity | Initial |
| | width | crystallite | retention | efficiency |
| | (°) | size (nm) | rate (%) | (%) |
| Example 7-1 | 0.756 | 11.42 | 79.3 | 86.5 |
| Example 7-2 | 0.796 | 10.84 | 79.6 | 86.3 |
| Example 7-3 | 1.025 | 8.55 | 79.8 | 86.4 |
| Example 7-4 | 1.218 | 7.21 | 79.8 | 86.4 |
| Example 7-5 | 1.271 | 6.63 | 80.8 | 86.3 |
| Example 7-6 | 1.854 | 4.62 | 80.9 | 86.4 |
| Example 1-2 | 2.257 | 3.77 | 81.3 | 86.7 |
| Example 7-7 | 2.593 | 3.29 | 81.8 | 86.6 |
| Example 7-8 | 10.123 | 1.524 | 82.3 | 86.7 |
| Example 7-9 | 20.221 | 0 | 82.6 | 86.6 |

SiOₓ: x=1, D₅₀=4 μm,
graphite: (natural graphite:artificial graphite=5:5), D₅₀=20 μm,
SiOₓ ratio: 10% by mass, Li₂SiO₃ and Li₄SiO₄,
carbon coating film: average thickness 100 nm,
presence of dQ/dV peak: yes,
reformation method: electrochemically, A>B,
content of silicon dioxide particle: 0.7% by mass,
presence or absence of composite secondary particle: presence,
inclusion of SiOₓ in composite secondary particle: yes,
average particle diameter of composite secondary particle: 7 μm,
cover of composite secondary particle with lithium: yes,
carbon content in composite secondary particle: 70 at % Xₛ<X

As can be seen in Table 7, when the half-value width was 1.20 or more and the crystallite's size attributable to the Si(111) surface was 7.5 nm or less, namely in the material with low crystallinity, a high capacity retention rate could be obtained. Especially, when the silicon compound was amorphous, the best characteristics could be obtained.

### Example 8-1

The secondary battery was fabricated with the same condition as Example 1-2 except that the relationship in the silicon compound between A and B was changed to A<B, wherein A is the maximum peak strength value in the Si and Li silicate regions and B is the peak strength value derived from the SiO₂ region; and then, the cycle characteristic and the first time efficiency were evaluated with the same condition as that of Example 1-2. In this case, by reducing the lithium insertion amount during reformation, amount of Li₂SiO₃ was reduced so as to decrease the peak strength A derived from Li₂SiO₃.

Evaluation results of Example 8-1 are shown in Table 8.

TABLE 8

| | Relationship | Capacity | Initial |
|---|---|---|---|
| | between | retention | efficiency |
| | A and B | rate (%) | (%) |
| Example 8-1 | A < B | 80.8 | 84.7 |
| Example 1-2 | A > B | 81.3 | 86.7 |

SiOₓ: x=1, D₅₀=4 μm,
graphite: (natural graphite:artificial graphite=5:5), D₅₀=20 μm,
SiOₓ ratio: 10% by mass, Li₂SiO₃ and Li₄SiO₄,
carbon coating film: average thickness 100 nm,
presence of dQ/dV peak: yes,
half-value width: 2.257°, crystallite: 3.77 nm,
reformation method: electrochemically,
content of silicon dioxide particle: 0.7% by mass,
presence or absence of composite secondary particle: presence,
inclusion of SiOₓ in composite secondary particle: yes,
average particle diameter of composite secondary particle: 7 μm,
cover of composite secondary particle with lithium: yes,
carbon content in composite secondary particle: 70 at % Xₛ<X

As can be seen in Table 8, the cycle characteristic as well as the initial charge and discharge characteristics could be improved when the relationship between A and B satisfied A>B.

### Example 9-1

The secondary battery was fabricated with the same condition as Example 1-2 except that the negative electrode active material which did not give the peak in the range of 0.40 to 0.55 V in any charge and discharge in the V-dQ/dV curve obtained in 30 charges and discharges in the test cell was used; and then, the cycle characteristic and the first efficiency were evaluated with the same condition as that of Example 1-2.

Evaluation results of Example 9-1 are shown in Table 9.

TABLE 9

| | | Capacity | Initial |
|---|---|---|---|
| | | retention | efficiency |
| | dQ/dV peak | rate (%) | (%) |
| Example 9-1 | Absence | 80.8 | 85.9 |
| Example 1-2 | Presence | 81.3 | 86.7 |

SiOₓ: x=1, D₅₀=4 μm,
graphite: (natural graphite:artificial graphite=5:5), D₅₀=20 μm,
SiOₓ ratio: 10% by mass, Li₂SiO₃ and Li₄SiO₄,
carbon coating film: average thickness 100 nm,
half-value width: 2.257°, crystallite: 3.77 nm,
reformation method: electrochemically, A>B,
content of silicon dioxide particle: 0.7% by mass,
presence or absence of composite secondary particle: presence,
inclusion of SiOₓ in composite secondary particle: yes,
average particle diameter of composite secondary particle: 7 μm,
cover of composite secondary particle with lithium: yes,
carbon content in composite secondary particle: 70 at % Xₛ<X

In order that the discharge curve rises more sharply, the silicon compound (SiOₓ) needs to show the same discharge behavior as silicon (Si). The silicon compound in which the peak does not appeared in the above-mentioned range in 30 charges and discharges had a comparatively gentle discharge curve, so that a slight deterioration was resulted in the initial charge and discharge characteristics upon making the secondary battery. When the peak appeared within 30 charges and discharges, a stable bulk could be formed so that the cycle characteristic as well as the initial charge and discharge characteristics could be improved.

### Examples 10-1 to 10-6

The secondary battery was fabricated with the same condition as Example 1-2 except that the median diameter of the negative electrode active material particle was changed as shown in Table 10; and then, the cycle characteristic and the first time efficiency were evaluated with the same condition as that of Example 1-2.

Evaluation results of Examples 10-1 to 10-6 are shown in Table 10.

TABLE 10

| | Median | Capacity | Initial |
|---|---|---|---|
| | diameter | retention | efficiency |
| | (μm) | rate (%) | (%) |
| Example 10-1 | 0.1 | 78.9 | 86.0 |
| Example 10-2 | 0.5 | 80.0 | 86.1 |
| Example 10-3 | 1 | 80.4 | 86.2 |
| Example 1-2 | 4 | 81.3 | 86.7 |
| Example 10-4 | 10 | 80.2 | 86.5 |
| Example 10-5 | 15 | 80.2 | 86.5 |
| Example 10-6 | 20 | 79.0 | 86.2 |

SiOₓ: x=1,
graphite: (natural graphite:artificial graphite=5:5), D₅₀=20 μm,
SiOₓ ratio: 10% by mass, Li₂SiO₃ and Li₄SiO₄,
carbon coating film: average thickness 100 nm,
presence of dQ/dV peak: yes,
half-value width: 2.257°, crystallite: 3.77 nm,
reformation method: electrochemically, A>B content of silicon dioxide particle: 0.7% by mass,
presence or absence of composite secondary particle: presence,
inclusion of SiOₓ in composite secondary particle: yes,
average particle diameter of composite secondary particle: 7 μm,
cover of composite secondary particle with lithium: yes,
carbon content in composite secondary particle: 70 at % Xₛ<X

As can be seen in Table 10, when the median diameter of the negative electrode active material particle was 1.0 μm or more, the cycle characteristic could be improved. This is presumably because the surface area of the silicon compound per unit mass was not too large that the area to cause a side reaction could be made small. On the other hand, when the median diameter is 15 μm or less, the particle does not easily crack upon charging so that SEI (solid electrolyte interface) due to the new surface is difficult to be formed upon charging and discharging; and thus, the reversible Li loss can be suppressed. In addition, when the median diameter of the silicon-based active material particle is 15 μm or less, expansion amount of the silicon compound particle upon charging is not so much that physical and electrical destruction of the negative electrode active material layer due to expansion can be prevented.

### Examples 11-1 to 11-4

The secondary battery was fabricated with the same condition as Example 1-2 except that the average thickness of the carbon coating film on surface of the silicon-based active material particle was changed; and then, the cycle characteristic and the first efficiency were evaluated with the same condition as that of Example 1-2. The average thickness of the carbon coating film can be controlled by changing the condition of the thermal decomposition CVD.

Evaluation results of Examples 11-1 to 11-4 are shown in Table 11.

TABLE 11

| | Average | Capacity | Initial |
|---|---|---|---|
| | thickness | retention | efficiency |
| | (μm) | rate (%) | (%) |
| Example 11-1 | 5 | 80.1 | 86.0 |
| Example 11-2 | 10 | 81.2 | 86.3 |
| Example 1-2 | 100 | 81.3 | 86.7 |
| Example 11-3 | 1000 | 81.5 | 86.8 |
| Example 11-4 | 5000 | 81.4 | 86.8 |

SiOₓ: x=1, D₅₀=4 μm,
graphite: (natural graphite:artificial graphite=5:5), D₅₀=20 μm,
SiOₓ ratio: 10% by mass, Li₂SiO₃ and Li₄SiO₄,
Presence of dQ/dV peak: yes,
half-value width: 2.257°, crystallite: 3.77 nm,
reformation method: electrochemically, A>B,
content of silicon dioxide particle: 0.7% by mass,
presence or absence of composite secondary particle: presence,
inclusion of SiOₓ in composite secondary particle: yes,
average particle diameter of composite secondary particle: 7 μm,
cover of composite secondary particle with lithium: yes,
carbon content in composite secondary particle: 70 at % Xₛ<X

As can be seen in Table 11, when the film thickness of the carbon coating film is 10 nm or more, especially the conductivity increases so that the cycle characteristic as well as the initial charge and discharge characteristics can be improved. On the other hand, when the film thickness of the carbon coating film is 5000 nm or less, amount of the silicon compound included in the silicon compound particle can be satisfactorily secured upon designing, so that the battery capacity can be sufficiently ensured.

### Example 12-1

The secondary battery was fabricated with the same condition as Example 1-2 except that the reformation method was changed to the thermal doping method; and then, the cycle characteristic and the initial efficiency were evaluated with the same condition as that of Example 1-2. In Example 12-1, first, the silicon compound particle was prepared; and then, the carbon coating film formation was carried out in the same way as Example 1-2. Thereafter, by the thermal doping method using LiH powder, lithium was inserted into the silicon compound particle covered with the carbon coating film as mentioned above.

Evaluation results of Example 12-1 are shown in Table 12.

TABLE 12

| | Half- | | | | |
|---|---|---|---|---|---|
| | value | Si(111) | Refor- | Capacity | Initial |
| | width | crystallite | mation | retention | efficiency |
| | (°) | size (nm) | method | rate (%) | (%) |
| Example 12-1 | 1.755 | 4.86 | Thermal | 81.0 | 86.4 |
| | | | doping | | |
| Example 1-2 | 2.257 | 3.77 | Electro- | 81.3 | 86.7 |
| | | | chemical | | |

SiOₓ: x=1, D₅₀=4 μm,
graphite: (natural graphite:artificial graphite=5:5), D₅₀=20 μm,
SiOₓ ratio: 10% by mass, Li₂SiO₃ and Li₄SiO₄,
carbon coating film: average thickness 100 nm,
presence of dQ/dV peak: yes, A>B content of silicon dioxide particle: 0.7% by mass,
presence or absence of composite secondary particle: presence,
inclusion of SiOₓ in composite secondary particle: yes,
average particle diameter of composite secondary particle: 7 μm,
cover of composite secondary particle with lithium: yes,
carbon content in composite secondary particle: 70 at %

Xₛ<X

Even when the thermal doping method was used, excellent battery characteristics could be obtained. By heating, crystallinity of the silicon compound particle was also changed. In any reformation method, excellent capacity retention rate as well as excellent initial efficient could be obtained.

### Example 13-1

The secondary battery was fabricated with the same condition as Example 1-2 except that the mass ratio of the silicon-based active material in the mixed negative electrode active material was changed; and then, the rate of increase in the battery capacity was evaluated.

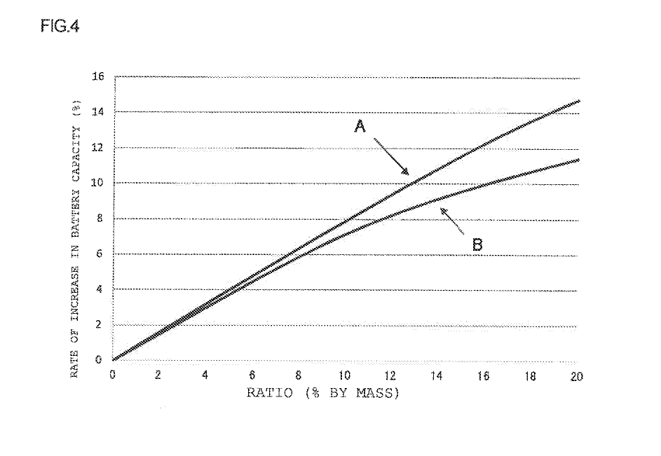

In FIG. 4, the graph is shown in which the relationship between the ratio of the silicon-based active material to the total amount of the mixed negative electrode active material and the rate of increase in the battery capacity of the secondary battery is shown. The graph shown with A of FIG. 4 shows the rate of increase in the battery capacity when the ratio of the silicon-based active material in the mixed negative electrode active material of the negative electrode of the present invention is increased. On the other hand, the graph shown with B of FIG. 4 shows the rate of increase in the battery capacity when the ratio of the silicon-based active material not doped with Li is increased. As can be seen in FIG. 4, when the ratio of the silicon-based active material is 6% by mass or more, the rate of increase in the battery capacity is larger as compared with the conventional case, so that especially the volume energy density increases remarkably.

It must be noted here that the present invention is not limited to the embodiments as described above. The foregoing embodiments are mere examples; any form having substantially the same composition as the technical idea described in claims of the present invention and showing similar effects is included in the technical scope of the present invention.

1-16. (canceled)

17. A negative electrode active material, wherein
the negative electrode active material comprises a negative electrode active material particle;
the negative electrode active material particle comprises silicon compound particle comprising a silicon compound (SiOₓ: 0.55≤x≤1.6);
the silicon compound particle comprises at least any one or more of Li₂SiO₃ and Li₄SiO₄;
the negative electrode active material comprises 2% by mass or less of silicon dioxide particle and comprises a silicon dioxide-carbon composite secondary particle comprising a plurality of the silicon dioxide particles and carbon; and
the composite secondary particle includes a lithium compound in at least part of a portion other than a silicon dioxide or a silicon compound (SiOₓ: 0.5≤x≤1.6) in the composite secondary particle.

18. The negative electrode active material according to claim 17, wherein the composite secondary particle further comprises the silicon compound particle and an average particle diameter of the composite secondary particle is 1 μm or more and 15 μm or less.

19. The negative electrode active material according to claim 17, wherein a ratio of carbon in the composite secondary particle is in a range of 60 at % or more.

20. The negative electrode active material according to claim 18, wherein a ratio of carbon in the composite secondary particle is in a range of 60 at % or more.

21. The negative electrode active material according to claim 17, wherein in the silicon compound particle included in the composite secondary particle, Xₛ and X are in a relationship of Xₛ<X, wherein Xₛ is defined as an oxygen/silicon molar ratio in a region of 5 nm or less from surface of the silicon compound particle and X is defined as an oxygen/silicon molar ratio in a region of 100 nm or more from surface of the silicon compound particle.

22. The negative electrode active material according to claim 18, wherein in the silicon compound particle included in the composite secondary particle, Xₛ and X are in a relationship of Xₛ<X, wherein Xₛ is defined as an oxygen/silicon molar ratio in a region of 5 nm or less from surface of the silicon compound particle and X is defined as an oxygen/silicon molar ratio in a region of 100 nm or more from surface of the silicon compound particle.

23. The negative electrode active material according to claim 19, wherein in the silicon compound particle included in the composite secondary particle, Xₛ and X are in a relationship of Xₛ<X, wherein Xₛ is defined as an oxygen/silicon molar ratio in a region of 5 nm or less from surface of the silicon compound particle and X is defined as an oxygen/silicon molar ratio in a region of 100 nm or more from surface of the silicon compound particle.

24. The negative electrode active material according to claim 20, wherein in the silicon compound particle included in the composite secondary particle, Xₛ and X are in a relationship of Xₛ<X, wherein Xₛ is defined as an oxygen/silicon molar ratio in a region of 5 nm or less from surface of the silicon compound particle and X is defined as an oxygen/silicon molar ratio in a region of 100 nm or more from surface of the silicon compound particle.

25. The negative electrode active material according to claim 17, wherein in the silicon compound particle, a half-value width (2θ) of a diffraction peak attributable to a Si(111) crystal plane obtained from an X-ray-diffraction is 1.2° or more, and a crystallite's size corresponding to this crystal plane is 7.5 nm or less.

26. The negative electrode active material according to claim 17, wherein the silicon compound particle satisfies a relationship that A>B, wherein A is a maximum peak strength value in a Si and a Li silicate regions given as a chemical shift value of −60 ppm to −95 ppm and B is a peak strength value in a SiO₂ region given as a chemical shift value of −96 ppm to −150 ppm, these peaks being obtained from a ²⁹Si-MAS-NMR spectrum thereof.

27. The negative electrode active material according to claim 17, wherein a test cell is prepared, the test cell comprising a negative electrode, which comprises a mixture of the negative electrode active material and a carbon-based active material, and a counter lithium; in the test cell, charge in which a current is flowed so as to insert lithium into the negative electrode active material and discharge in which a current is flowed so as to release lithium from the negative electrode active material are executed for 30 times; and when a graph is drawn showing a relationship between a differential value dQ/dV, which is obtained by differentiating a discharge capacity Q in each charge and discharge with an electric potential V of the negative electrode with a standard of the counter lithium, and the electric potential V, the differential value dQ/dV upon discharging on and after X^{th} time (1≤X≤30) has a peak in a range of 0.40 V to 0.55 V of the electric potential V of the negative electrode.

28. The negative electrode active material according to claim 17, wherein the negative electrode active material particles has a median diameter of 1.0 μm or more and 15 μm or less.

29. The negative electrode active material according to claim 17, wherein the silicon compound particle has a carbon coating film on a surface thereof.

30. The negative electrode active material according to claim 29, wherein an average thickness of the carbon coating film is 10 nm or more and 5000 nm or less.

31. A material of mixed negative electrode active material, wherein the material of mixed negative electrode active material comprising the negative electrode active material according to claim 17 and a carbon-based active material.

32. A negative electrode for a non-aqueous electrolyte secondary battery wherein the negative electrode contains the material of mixed negative electrode active material according to claim 31, and a ratio of a mass of the negative electrode active material relative to a total mass of the negative electrode active material and the carbon-based active material is 6% by mass or more.

33. A negative electrode for a non-aqueous electrolyte secondary battery comprising:
a negative electrode active material layer formed by the material of mixed negative electrode active material according to claim 31; and
a negative electrode current collector, wherein
the negative electrode active material layer is formed on the negative electrode current collector, and
the negative electrode current collector comprises carbon and sulfur with the contents of each being 100 ppm by mass or less.

34. A lithium ion secondary buttery wherein a negative electrode comprising the negative electrode active material according to claim 17 is used as the negative electrode thereof.

35. A method for producing a negative electrode active material, the method being a method for producing a negative electrode active material comprising negative electrode active material particle which comprises silicon compound particle, and the method comprising:
preparing the negative electrode active material particle, the preparing the negative electrode active material particle comprising making silicon compound particle which comprises a silicon compound (SiOₓ: 0.5≤x≤1.6),
compounding carbon with the silicon compound particle, and
inserting Li into the silicon compound particle so as to include at least any one or more of Li₂SiO₃ and Li₄SiO₄ in the silicon compound particle; and
selecting a negative electrode active material which comprises 2% by mass or less of silicon oxide particle and comprises a silicon oxide-carbon composite secondary particle comprising a plurality of the silicon oxide particles and carbon, the composite secondary particle comprising a lithium compound in at least part of a portion other than a silicon dioxide or a silicon compound (SiOₓ: 0.5≤x≤1.6) in the composite secondary particle from a negative electrode active material comprising the prepared negative electrode active material particle.

36. A method for producing a lithium ion secondary battery, wherein a negative electrode is produced by using the negative electrode active material produced by the method for producing the negative electrode active material according to claim 35, and the lithium ion secondary battery is produced by using the negative electrode thus produced.
